(19) United States
(12) Patent Application Publication
(10) Pub. No.: US 2005/0008986 A1
(43) Pub. Date: Jan. 13, 2005

(54) Multi-directional motion flosser

(76) Inventors: Gary Sokol, Longmont, CO (US); Cliff Snyder, Fort Collins, CO (US); Arthur W. Ellsworth, Orange, CA (US); Dennis Grudt, Long Beach, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/843,094

(22) Filed: May 10, 2004

Related U.S. Application Data
(63) Continuation-in-part of application No. 10/238,666, filed on Sep. 9, 2002.
Application No. 10/238,666 is a division of application No. 09/636,488, filed on Aug. 10, 2000, now Pat. No. 6,447,293.
(60) Provisional application No. 60/469,174, filed on May 9, 2003.

(51) Int. Cl. B65F 3/00

(52) U.S. Cl. 433/127; 433/118

(57) ABSTRACT

An improved flossing device for cleaning between one's teeth is provided. The flossing device comprises a motor with a rotation drive shaft, a link member, and a motion translator. The link member has a first end and a second end, the first end adapted to receive a removable floss tip member. The motion translator is configured to transfer rotational motion of the drive shaft to the second end of the link member in the form of axial motion. In alternate embodiments, the motion translator transfers at least two types of motion from the group of vibrating, rotating, and axial motion to the second end of the link member.

### CROSS REFERENCES TO RELATED APPLICATIONS

This application is a non-provisional application claiming priority to U.S. Provisional Application No. 60/469,174, entitled “Axial Motion Flosser,” filed May 9, 2003. This application is also a continuation-in-part of U.S. application Ser. No. 10/238,666, entitled “Drive Mechanism for Interproximal Flossing Device,” filed Sep. 9, 2002, which is a divisional of U.S. patent application Ser. No. 09/636,488, now U.S. Pat. No. 6,447,293, filed Aug. 10, 2000. The contents of each of these applications is hereby incorporated by reference in its entirety.

### FIELD OF THE INVENTION

This invention relates to interproximal flossing devices, and more particularly to the drive mechanisms for interproximal flossing devices and the tip attachment structure associated therewith.

### BACKGROUND OF THE INVENTION

Available interproximal flossers employ a variety of tip movements to effect cleaning interproximal spaces formed between teeth. The tip movements typically include orbital, rotational, linear, or reciprocal axial movement. Rotational movement is typically created by a direct linkage between the tip and the drive shaft of a motor mounted in the handle. As the drive shaft rotates, the linkage and tip also rotate accordingly. Typically the rotation occurs in one direction, but rotary oscillation may also be employed

Orbital movement may be created by using an off-center weight attached to a drive shaft of an electric motor mounted in the handle, which cause the entire device to move in an orbital manner (e.g., in a circular or elliptical path) in response to the movement of the off-center weight.

Linear movement typically requires a linkage converting the rotational movement of the motor drive shaft into linear, oscillating movement at the tip. Oftentimes the structure for converting rotational to linear movement requires an offset cam surface mounted on the shaft of the motor, with an end of the linkage attached thereto to follow the eccentric cam as it rotates. The end of the shaft is generally loosely engaged with the offset cam surface so that the shaft only moves in a direction creating linear motion at the tip end. In the linkage used to convert rotational movement to linear movement, there can be inefficiencies in linkage connections (such as from loose engagement). It may also be difficult to quietly connect the linkage to the motor in order to avoid the creation of annoying sounds, such as those generated by loose connections when the motor operates.

Reciprocal axial movement is similar to linear movement in that it also requires a linkage converting the rotational movement of the motor drive shaft into reciprocal movement at the tip. One exemplary linkage for such conversion is a track cam arrangement. A cam having an angled surface is mounted on the end of the drive shaft. The bottom end of the linkage is generally loosely engaged with the angled cam surface so that the cam can rotate within the end of the linkage shaft. The corresponding linkage end includes an angled track for receiving the angled cam. As the cam rotates within the angled track of the linkage end, the loosely engaged linkage bobs up and down, as opposed to the fixed positioning of the motor and cam. The end result is that the tip member moves in an axial manner. Typically, the tips or ends of existing interproximal flossing devices do not include an axial motion in any combination of tip motions. Combining axial motion with other motions, however, generally provides a more effective device.

In addition, the tip connection structure typically used in interproximal flossing devices utilizes simple friction to attach the tip to the active end of the drive train. This type of connection is not secure, and can wear out and be less effective as the device is used.

Accordingly, an improved flosser is needed.

### SUMMARY OF THE INVENTION

Embodiments of the present invention provide an interproximal flossing device capable of providing axial motion to a removable floss tip member. The device includes a motor with a rotational drive shaft, a link member, and a motion translator. The link member has a first end and a second end, the first end configured to receive the removable floss tip. The motion translator is adapted to transfer the rotational motion of the drive shaft to the second end of the link member in the form of axial motion. Alternate embodiments of the present invention provide a motion translator configured to provide at least two types of motion from the group of vibrational, rotational, and axial motion.

In one embodiment of the invention, the motion translator includes a pivot arm attached at one end to the link member, and at the other end to an eccentric cam coupled with the drive shaft. The cam has an angled top surface that, along with a spring and a floating support coupled with the pivot arm, provides vibrational and axial movement of the pivot arm and the link member.

In a second embodiment of the invention, the motion translator includes a pivot arm pin in addition to the pivot arm, eccentric cam, and spring. The pin essentially prohibits rotation of the pivot arm. Therefore, the motion translator of this embodiment provides vibrational and axial movement of the pivot arm and, hence, the link member.

In a third embodiment of the invention, the motion translator provides upper and lower vibration-dampening supports in addition to the eccentric cam, spring, and a rotating arm. As a result, the motion translator supports the transfer of rotational and axial motion to the link member.

According to a fourth embodiment of the invention, a spring is not employed. Additionally, a pivot support is coupled with a pivot arm, and the eccentric cam has a flat surface. Accordingly, axial motion of the pivot arm is substantially limited. The motion translator thus transfers vibrational and rotational motion to the link member in this case.

In addition, alternate embodiments of the present invention provide a drive mechanism for an interproximal flosser providing the aforementioned capabilities regarding axial, vibrational, and rotational motion of a floss tip member that may be attached to the flosser.

### BRIEF DESCRIPTION OF THE DRAWINGS

FIG. 1 depicts a top view of a flossing device incorporating the drive mechanism of the present invention, showing the primary internal working parts in dashed lines.

FIG. 2 depicts an enlarged cross-sectional view taken along line 2-2 of FIG. 1, showing internal parts.

FIG. 3 depicts an enlarged cross-sectional view similar to that of FIG. 2.

FIG. 3A is a section view taken along respective lines of FIG. 3.

FIG. 3B is a section view taken along respective lines of FIG. 3.

FIG. 3C is a section view taken along respective lines of FIG. 3.

FIG. 3D is a section view taken along respective lines of FIG. 3.

FIG. 3E is a section view taken along respective lines of FIG. 3.

FIG. 3F is a section view taken along respective lines of FIG. 3.

FIG. 3G is a section view taken along respective lines of FIG. 3.

FIG. 3H is a section view taken along respective lines of FIG. 3.

FIG. 3I is a section view taken along respective lines of FIG. 3.

FIG. 4 depicts a top schematic view of the drive mechanism of the flosser of FIG. 1, with the eccentric drive member in a first position.

FIG. 4A depicts a top schematic view of the drive mechanism of the flosser of FIG. 1, with the eccentric drive member in a second position.

FIG. 4B depicts a top schematic view of the drive mechanism of the flosser of FIG. 1, with the eccentric drive member in a third position.

FIG. 4C depicts a top schematic view of the drive mechanism of the flosser of FIG. 1, with the eccentric drive member in a fourth position.

FIG. 5 depicts a section view taken along respective lines in FIG. 4 showing the drive mechanism in a first position.

FIG. 5A depicts a section view taken along respective lines in FIG. 4A showing the drive mechanism in a second position.

FIG. 5B depicts a section view taken along respective lines in FIG. 4B showing the drive mechanism in a third position.

FIG. 5C depicts a section view taken along respective lines in FIG. 4C showing the drive mechanism in a fourth position.

FIG. 6 shows a second embodiment of the drive mechanism.

FIG. 6A is a section view taken along respective lines of FIG. 6.

FIG. 6B is a section view taken along respective lines of FIG. 6.

FIG. C1 is a section view taken along respective lines of FIG. 6.

FIG. C2 is a section view taken along respective lines of FIG. 6.

FIG. C3 is a section view taken along respective lines of FIG. 6.

FIG. D is a section view taken along respective lines of FIG. 6.

FIG. 7 shows a third embodiment of a drive mechanism in cross-section.

FIG. 8 shows a fourth embodiment of a drive mechanism in cross-section.

FIG. 9 shows a fifth embodiment of a drive mechanism in cross-section.

FIG. 10A depicts a sixth embodiment of a drive mechanism in cross-section.

FIG. 10B depicts the drive mechanism of FIG. 10A in cross-section.

FIG. 11 shows a seventh embodiment of a drive mechanism.

FIG. 12 shows an eighth embodiment of a drive mechanism.

FIG. 13 shows a ninth embodiment of a drive mechanism.

FIG. 14 shows a tenth embodiment of a drive mechanism having a more significant angle between the first and second portions of the link member.

FIG. 15 shows the tip member, including the tip cap, the flossing element, and the recess groove.

FIGS. 16A and 16B show the first end of the link member for receiving the tip member, and shows the key structure.

FIGS. 17A-D show the tip member without the secondary key structure, and the connection structure for attachment to the link member.

FIGS. 17E-H show another embodiment of the tip member and the connection structure for attachment to the link member.

FIGS. 18A-E show the link member, including the latch tabs.

FIGS. 19, 19A, 19A1 and 19B show a tip removal and storage structure having a tip removal slot.

FIG. 20 shows the tip member attaching to the end of the link member.

FIGS. 21A, 21B and 21C show another embodiment of the tip removal slot.

FIGS. 21A, B and C show a second embodiment of the tip removal slot.

FIG. 22 shows a detail of the second embodiment of the tip removal slot.

FIG. 23 shows an eleventh embodiment of a drive mechanism.

FIG. 23A is a top section view of the embodiment illustrated in FIG. 23.

FIG. 24 shows a twelfth embodiment of a drive mechanism.

FIG. 24A is a top section view of the embodiment illustrated in FIG. 24.

FIG. 25 shows a thirteenth embodiment of a drive mechanism.

FIG. 25A is a top section view of the embodiment illustrated in FIG. 25.

FIG. 26 shows a fourteenth embodiment of a drive mechanism.

FIG. 26A is a top section view of the embodiment illustrated in FIG. 26.

### DETAILED DESCRIPTION

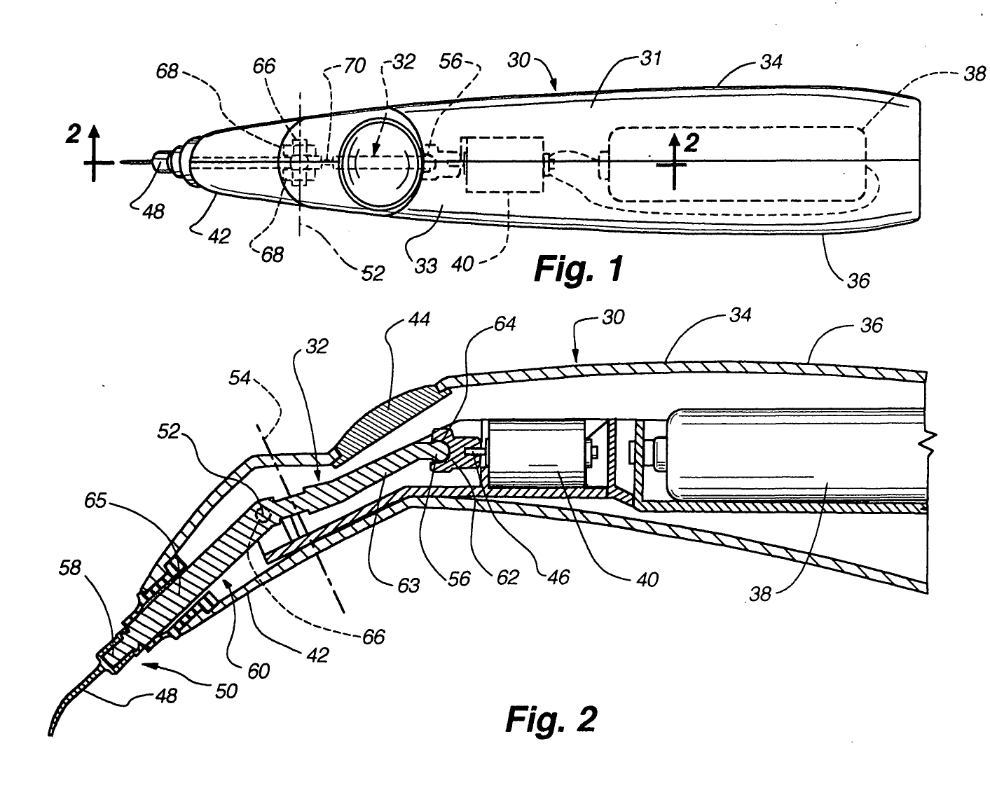

Referring first to FIGS. 1 and 2, an interproximal flosser 30 having a linear drive linkage 32 in accordance with one embodiment of the present invention is shown. The interproximal flosser includes a housing 34 divided into two opposing sections 31, 33, a handle 36 in which the battery 38 and motor 40 reside, and a tip portion 42. The tip portion 42 of the housing 34 encloses the linear drive linkage 32 as well as the on/off button 44. The tip portion 42 generally extends at an acute angle (shown to better effect in FIG. 2) from the handle 36 to provide a desired handle/tip portion orientation for use. In the present embodiment, the tip portion 42 extends downwardly from the handle 36. Alternate embodiments may orient the tip upwardly from the handle, or may change the angle therebetween.

The motor 40 is a DC motor, known or available in the art, which includes a drive shaft 46 which is driven in rotation by the motor. The motor 40 is powered by a battery, such as a AA or AAA battery, which can be rechargeable as is known or available in the art. Optionally, the motor may be powered by an external power source such as a wall socket. Other batteries or portable power sources may also be used with the present invention. The motor shaft 46 is attached to one end of the linear drive linkage 32. The linkage extends inside the tip portion 42 through the terminal end of the housing, and outside the tip portion 42. The exposed end 58 of the drive linkage 32 receives a flossing member 48 through the use of a tip connection structure 50, described in detail below.

The linear drive linkage 32 converts rotational movement of the motor drive shaft 46 to linear movement of the flossing member 48. This is done by combining a horizontally-oriented pivot axis 52 with a vertically-oriented hinge (i.e., a hinge having a vertical bending axis) for the drive linkage 32. These opposing axes effectively convert an orbital movement expressed by the linkage's first end 56 into a linear movement at the linkage's second end 58.

In greater detail and with respect to FIG. 2, the linear drive linkage 32 includes a single elongated link member 60 having a first end 56 operably connected to the drive shaft 46 of the motor 40, and a second exposed end 58 extending from the tip portion 42 of the handle 36 for receiving the tip or flossing member 48. The motor 40 generally rotates the drive shaft 46 about the longitudinal axis of the housing 30. The linear drive linkage 32 extends at an acute angle (downwardly in FIG. 2) to follow the shape of the housing.

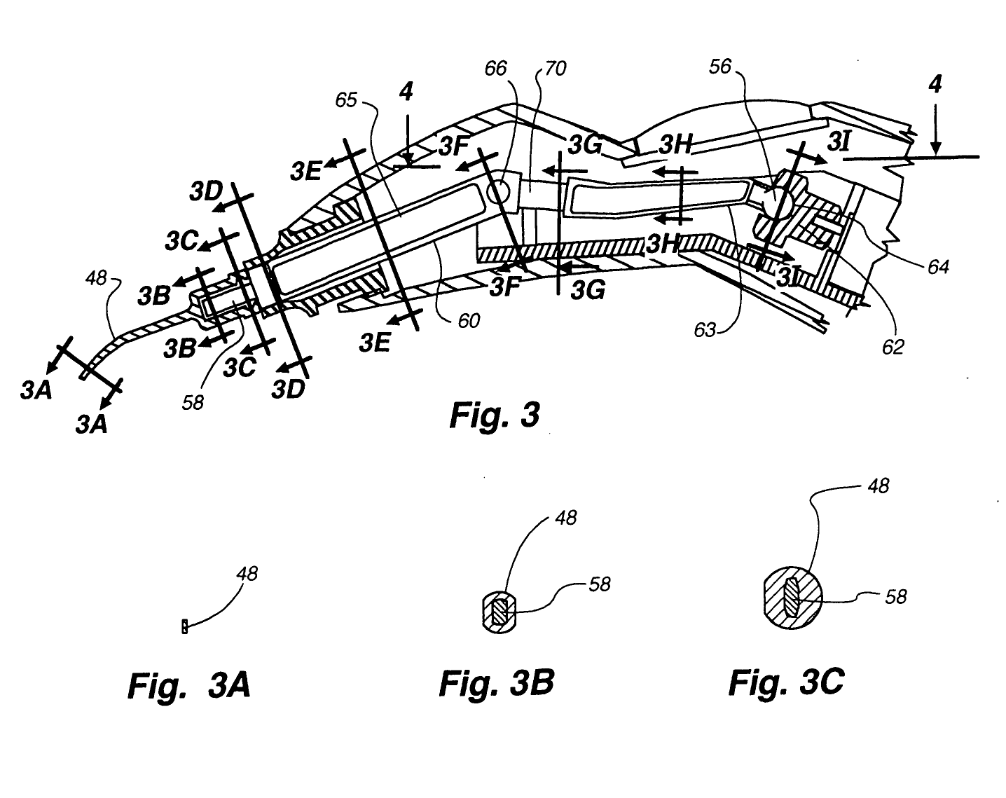

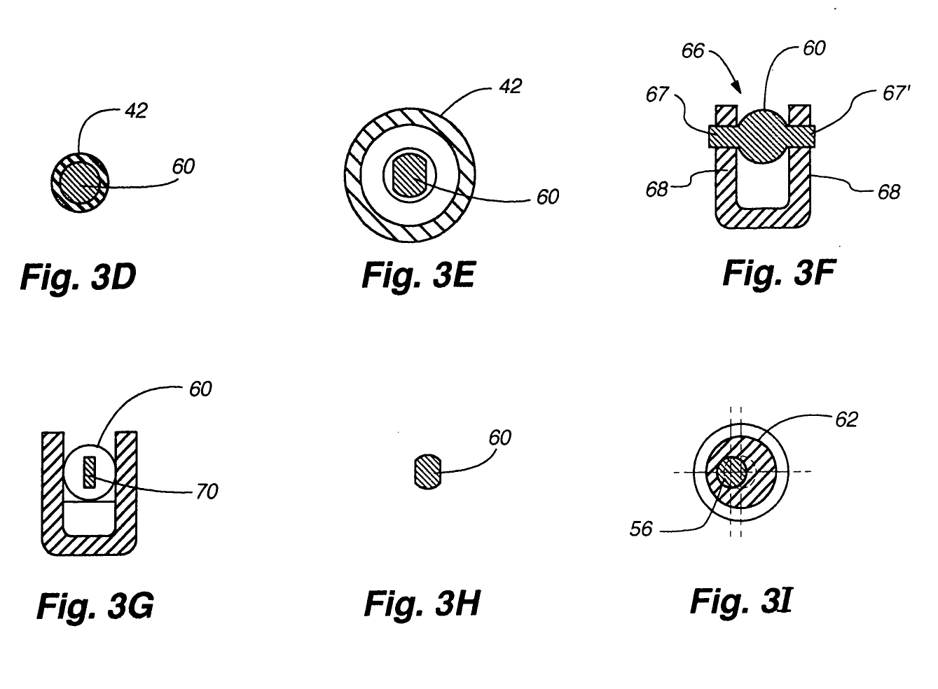

As shown in FIGS. 2 and 3, the first end 56 of the link member 60 is attached to a drive member 62 (such as an offset connector), which is affixed to the shaft 46 of the motor 40 and rotates with the shaft of the motor. The outer end of the drive member 62 defines an off-center recess 64, for instance a partially spherical cavity, for receiving the first end 56 of the link member 60. The recess 64 may be of any longitudinal or lateral cross-sectional shape without departing from the spirit or scope of the invention. As the offset recess 64 rotates with motion of the drive member 62 and associated shaft 46, the coupled first end 56 moves in an orbital manner around the shaft's 46 centerline. The motion of the recess and the link member's first end 56 is generally orbital about the drive shaft 46.

Generally, the recess 64 and first end 56 take the form of a ball-and-socket structure. The first end 56 of the link member 60 is tightly held in the recess 64 to minimize noise caused by the relative movement of the drive member and the first end during operation. Further, the plastic materials typically utilized to fabricate the first end 56 and the recess 64 minimize friction therebetween, reducing wear and tear and energy consumption of the motor.

The link member 60 is divided into two portions, the first portion 63 associated with the first end 56 and the second portion 65 associated with the second end 58. The two halves are generally delineated by a pivot 66, as shown in FIGS. 2 and 3. The pivot 66 extends horizontally (i.e., laterally and at a right angle with the centerline of the flossing device). Further, the pivot 66 restricts member 60 with respect to link movement to a plane parallel to the longitudinal axis of the flosser 30, about the pivot. As best seen in FIG. 3F, which is a cross-section taken along line 3F-3F on FIG. 3, the pivot 66 is formed by two cylindrical protrusions 67, 67′, one extending from each side of the link member 60, each being rotatably received in a yoke 68 formed in the housing. These cylindrical protrusions 67, 67′ are restrained in the yoke 68, thus allowing the pivot 66 to rotate only about the pivot axis 52 (of FIG. 1). The yokes may be cylindrical recesses formed in the housing or other like structure.

Turning now to FIG. 3G, a flexible resilient hinge 70 is formed in the first portion 63 of the link member 60 adjacent to the pivot 66. The flexible hinge 70 has a height slightly less than the height of the link member 60, but is thin relative to the thickness of the link member in the side-to-side direction (see FIG. 3G). The flexible hinge 70 is ideally a living hinge. The hinge 70 and link member 60 may be made of the same material and integrated, or may be separate members. The flexible hinge 70 allows the first portion 63 of the link member 60 to bend laterally and twist axially when the first end 56 of the link member 60 moves with the rotation of the off-center recess 64. The hinge 70 twists and bends to absorb any lateral movement of the first end 56. This lateral movement and twisting motion is accordingly isolated by the hinge. Thus, the second section 65 of the link member 60 moves only in a linear manner (i.e., up and down) about the pivot axis 52 of the pivot 66. In one embodiment, the hinge is approximately 0.037 inches thick, 0.150 inches long, and 0.13 inches tall. The surrounding portion of the link member 60, before and after the hinge, is typically 0.1 inches thick, and at least 0.13 inches tall.

The hinge 70 is flexible and preferably resiliently biased in its original side-to-side position (i.e., its thin dimension). Further, the combination of the hinge 70 and the fixed pivot 66 isolates vertical motion from the generally rotary motion of the first section 63 of the link member 60. Thus, vertical oscillating motion is transmitted to the second section 65 of the link member 60 resulting in the flossing tip 48 moving in a vertical, planar, reciprocating motion.

When the first end 56 of the link member 60 moves up and down in response to the off-center recess 64 in the drive member 62 moving from top to bottom during rotation, the hinge 70 bends laterally and twists axially. However, the vertical dimension of the hinge 70 is substantially rigid and thus transfers vertical motion through the pivot point. This causes the pivot 66 to pivot along its horizontal axis 52. This, in turn, causes the second end 58 of the link member 60 to move through a vertical arc with respect to the longitudinal axis of the flosser 30. This motion is in a reciprocating and linear (or translatory), driving the end of the tip member 48 in an arcuate, vertical, up-and-down movement in a single plane. Such translatory motion of the tip 48 may facilitate cleaning interproximal spaces between teeth.

The second end 58 of the link member 60 is free to move in the translatory motion both inside and outside the housing 34. Thus, when a tip member 48 is attached to the second end 58, the tip member also moves in a translatory motion. The flexible hinge section 70 acts as a living hinge to effectively absorb and isolate side-to-side or lateral movement and twisting motion of the first end 56 allowing only vertical movement to be transferred to the second end 58. This isolation of vertical movement components from the lateral movement components yields a planar, arcuate tip motion. The pivot yokes 68 facilitate such movement isolation.

Due to the clearance required, typical cam and follower structures generate significant noise in a flosser 30 when the motor operates at or exceeds approximately 9,000 rpm, which is the operational spec of the present embodiment. To reduce this noise, the instant embodiment receives a ball-shaped first end 56 of the link member 60 in an off-center socket 64 of the drive member 62. The spherical shape of the first end can be more tightly toleranced with the off-center recess 64 in the drive member 62, thus minimizing required clearances and reducing noise level during operation. A ball and socket structure is shown in FIGS. 2 and 3.

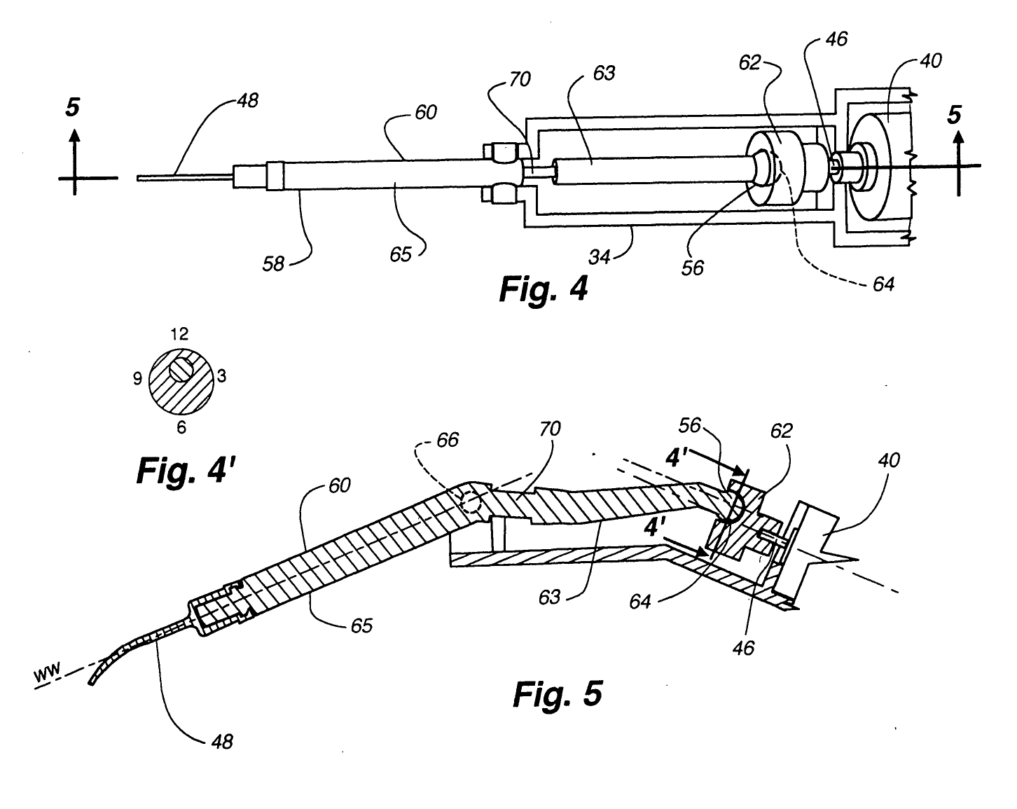

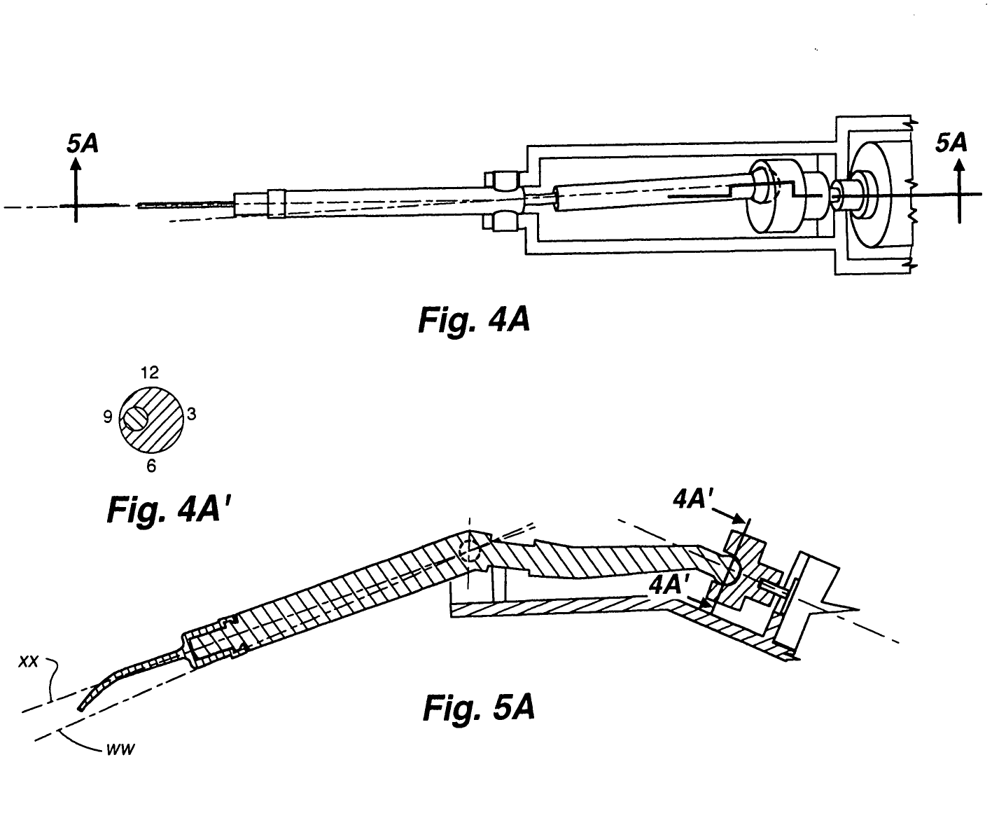

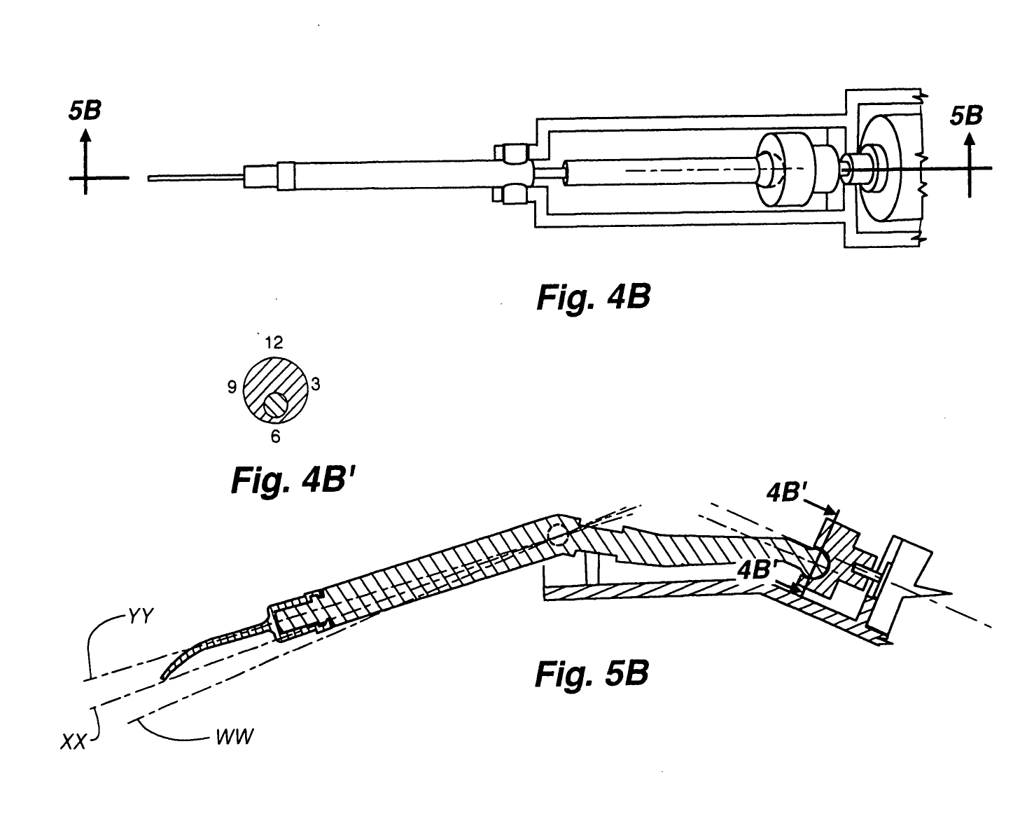

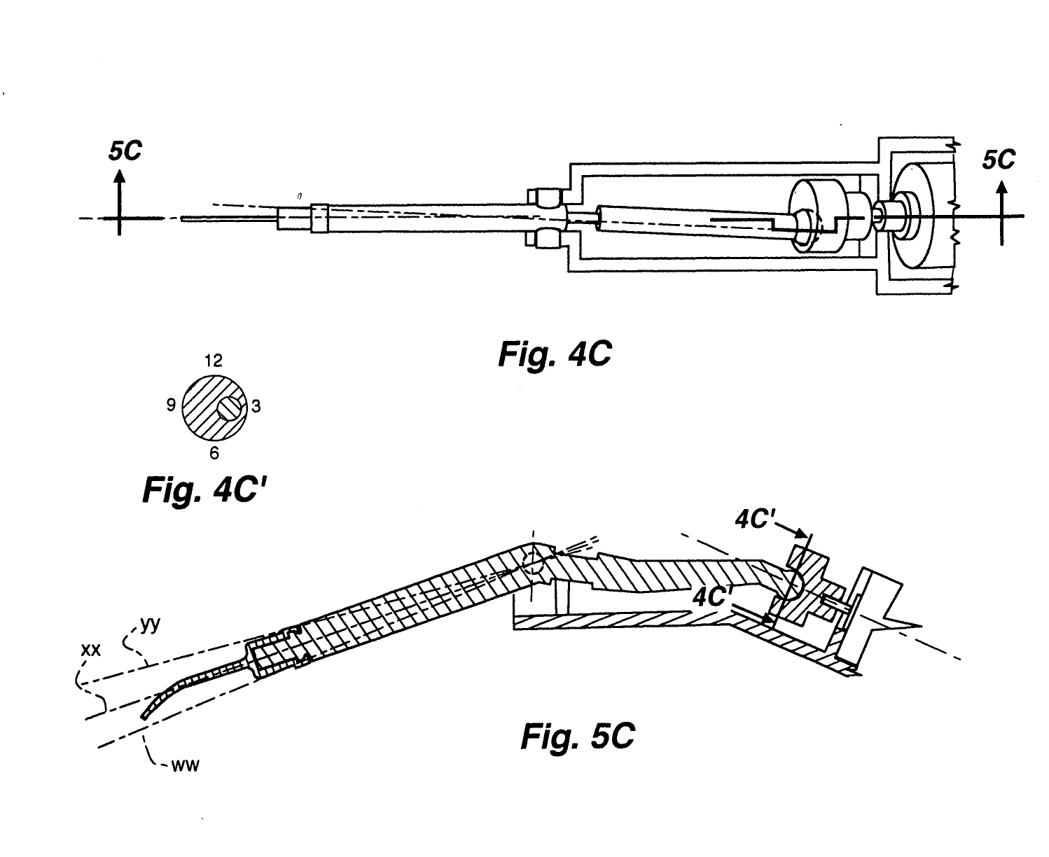

FIGS. 4, 4A, 4B, 4C, 5, 5A, 5B, and 5C schematically show the drive mechanism 32 of the present invention in four different positions illustrating motion of the flossing member 48 and second end 58 of the link member 60 relative to the first end 56 of the drive link member 60. FIGS. 4, 4A, 4B, and 4C show top views of the drive mechanism 32 in four consecutive positions. FIGS. 5, 5A, 5B, and 5C are vertical section views showing link member 60 and flossing member 48 positions corresponding to FIGS. 4, 4A, 4B, and 4C, respectively.

FIGS. 4 and 5 show the link member 60 with the drive member 62 in the top position (i.e., the offset recess is closest to the top, or 12 o'clock position, of the flosser 30), shown to best effect in FIGS. 4′ and 5. This is the largest positive vertical offset, smallest lateral offset position the first end 56 is subject to above the flosser's centerline. This corresponds to the lowest position of the second end 58 and the flossing member 48 insofar as the pivot 66 forces the first and second ends in opposing directions. In this position, the hinge 70 transfers all vertical motion of the first end 56 to the second end 58 through the pivot 66. This position is represented by dashed line w-w on FIG. 5.

FIGS. 4A and 5A show the link member 60 with the drive member 62 in the left-most position (i.e., the offset recess pointing generally at 9 o'clock in lateral cross-section, as shown in FIG. 4A′). This is the smallest vertical offset, and largest lateral offset, position the first end 56 occupies relative to the centerline, and equates to a first intermediate position of the second end 58 of the link member 60 and attached flossing member 48. In this position, the hinge 70 bends to absorb substantially all of the first end's lateral motion, thus isolating the second end 58 therefrom. The pivot 66 is not active while the link member 60 is in this “intermediate” or neutral position. The location of the flossing member 48 and the link member 60 in the neutral position is represented by dashed line x-x on FIG. 5A.

FIGS. 4B and 5B show the link member 60 with the drive member 62 in a “top” position (i.e., the offset recess pointing directly downwardly at 6 o'clock in lateral cross-section, as displayed in FIG. 4B′). Relatively, this is the largest vertical and smallest lateral offset position the first end 56 of the link member 60 is subject to below the centerline, and equates to the highest position of the second end 58 of the link member 60 and attached flossing member 48. In this position the hinge 70 transfers all vertical motion of the first end through the pivot 66 to the second end 58. This position is represented by dashed line y-y on FIG. 5B.

FIGS. 4C and 5C show the link member 60 with the drive member 62 in the right-most position (i.e., the offset recess pointing generally at 3 o'clock in lateral cross-section, as seen in FIG. 4C′). This is the smallest vertical offset and largest lateral offset position the first end 56 of the link member 60 is subject to relative to the centerline and equates to a second intermediate position of the second end 58 of the link member 60 and attached flossing member 48. In this position, the hinge 70 bends to absorb substantially all of the lateral motion of the first end of the link member 60, thus isolating the second end 58 of the link member 60 therefrom. The pivot 66 is not activated while the link member 60 is in this intermediate or neutral position. This position is represented by dashed line z-z in FIG. 5C.

The stroke of the flossing member 48 is thus represented by the plane formed between dashed line w-w and y-y, as shown in FIG. 5C. Ideally, in one embodiment the motion of the tip of the flossing member 48 is between approximately 0.050 inches and 0.070 inches inclusive, at an angle between 5 and 30 degrees inclusive (although no angle may be required if the entire flossing tip translates, as described below), and at a speed of approximately 9,000 cycles per second. As used herein one “cycle” refers to a single oscillation of the tip, i.e., motion from line x-x to line y-y, to line w-w, and returning to line x-x (or vice versa). The flossing member 48 is moved through this stroke efficiently and with reduced noise.

The structure described above with respect to FIGS. 1, 2, 3, 4-4C and 5-5C is one embodiment of the present invention. This embodiment reduces operating noise level, and also provides a convenient housing size for gripping and manipulation during operation by appropriately positioning the pivot 66 and supporting yoke 68. If the pivot 66 were located too close to the flossing member 48, the device would be more difficult to insert into a user's mouth. Similarly, if the pivot 66 were too far away from the flossing member 48, the device would be longer than is necessary, and the link member 60 would need to be larger to handle the moment loads. Nonetheless, a variety of differently-shaped and sized embodiments are possible and contemplated for converting rotational movement to the preferred translatory movement. The similarity between all such embodiments is that the link member 60 includes at least one element acting to isolate vertical motion of the link member. In the embodiment described above, two elements work in tandem to achieve isolation of motion, namely the hinge 70 and pivot 66.

Many embodiments of the present invention may include additional structural elements beyond those discussed herein, omit some elements herein disclosed, and/or change such structures. For example, in some embodiments the engagement of the drive shaft 46 of the motor 40 and the first end 56 of the link member 60 may vary. Some such alternative engagement means for converting rotation into linear motion are described below.

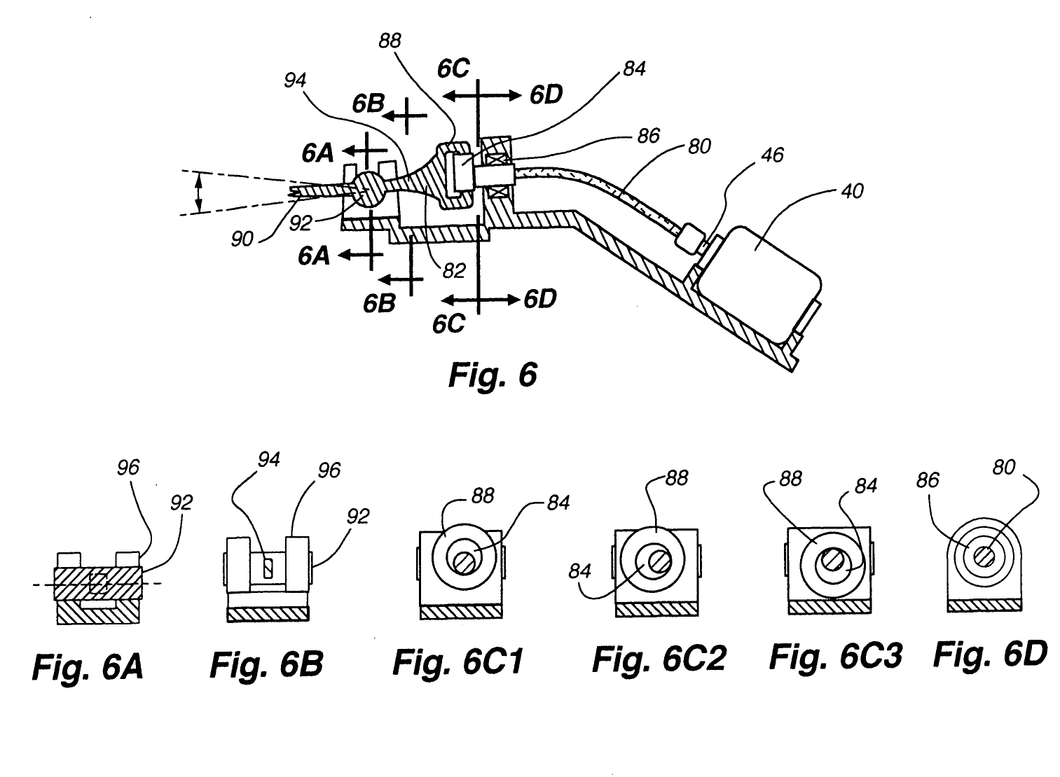

FIG. 6 shows an embodiment employing a flexible cable 80 to remotely position the connection of a link member 82 with the motor 40. For example, this could be helpful if the connection between link member 82 and motor 40 must be offset. In this embodiment, the cable 80 is attached at one end to the drive shaft 46, and at the other to an eccentric cam 84. A rotation bearing 86 supports the distal end of the cable and allows the cable to rotate with the drive shaft 46. The eccentric cam 84 can be used to drive the small link member 82, including a cam follower 88. The tip member (not shown) attaches to the end 90 of the small link member 82. The small link member has a pivot 92 to allow the link member to pivot about a fixed lateral axis (in FIG. 6, this lateral axis extends outwardly from the figure). The cam follower 88 follows the eccentric rotation of the cam 84 in the vertical, up-and-down direction. The small link member 82 forms a living hinge 94, similar to the previous embodiment, to absorb and isolate the lateral motion from the motion of the cam follower 88 by bending and twisting appropriately. This allows vertical motion to pass through the pivot 92 while blocking the aforementioned lateral motion, which in turn causes the flossing member to pivot up and down through a planar arc, as shown in FIG. 6.

FIG. 6A shows a cross-section of the small link member taken through the pivot protrusions 92 and support yokes 96. FIG. 6B shows a cross-section through the hinge section 94 of the small link member 82. FIGS. 6C1-6C3 show cross-sections of various positions of the cam follower 88 relative to the rotating drive shaft cable 80. FIG. 6C1 shows the cam follower 88 in its highest position. FIG. 6C2 shows the cam follower 88 at its largest lateral deviation, and FIG. 6C3 shows the cam follower 88 in its lowest position. FIG. 6D shows a section of the remote end of the drive shaft cable 80 moved in the rotation bearing 86.

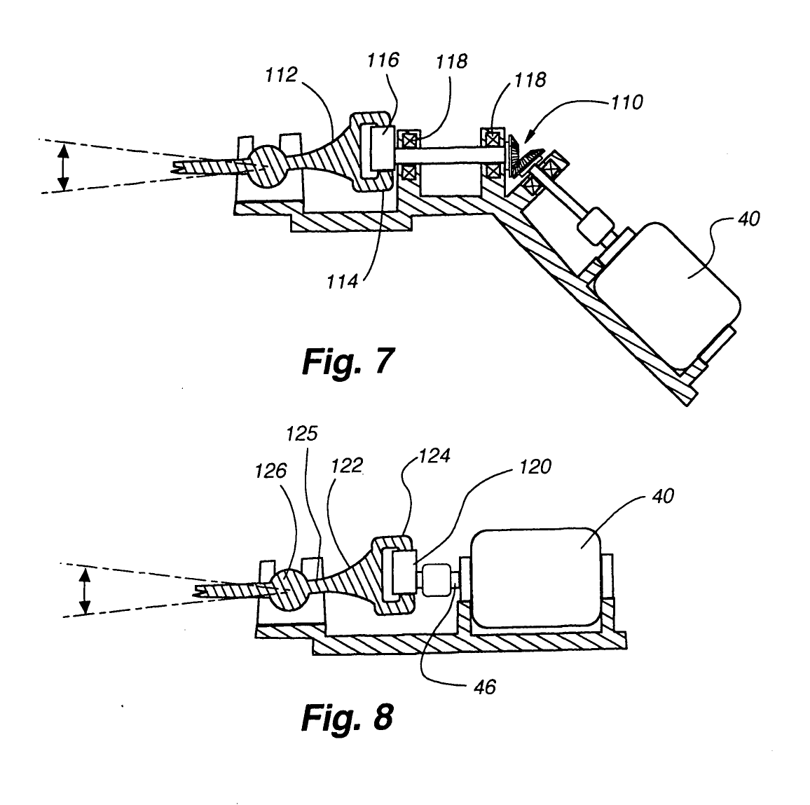

FIG. 7 shows an embodiment of the present invention utilizing bevel gears 110. The small link member 112 and cam follower 114, as well as motor 40, are identical to that described above with respect to FIG. 6. The structure of FIG. 7 allows angular relation of the input signal to output oscillation, but may also minimize parasitic drag on the system that may exist in the structure of FIG. 6. This structure may be less complex than use of a universal joint, which nonetheless could be used to replace the bevel gears 110. The gear shafts and attachment ends could optionally be molded as a single piece for each shaft. The eccentric element 116 also may be molded unitarily with one of the shafts. This design would require at least one, and possibly two, rotational bearing features 118 for each shaft, possibly resulting in parasitic drag. Additionally, gear noise and/or heat buildup may occur at the gear faces. However, in the present embodiment the output speed (tip movement frequency) may be varied from the motor rotational speed by adjusting the gears 110. This may be beneficial in terms of cleaning effectiveness, motor selection, flexibility, and/or power requirements.

The cam followers 88, 114 of the structures shown in FIGS. 6 and 7 can be designed to follow only motion of the eccentric elements 84, 116 in the vertical plane, and not in the lateral plane. Accordingly, the associated link member may omit a flexible hinge portion isolating vertical motion.

FIG. 8 shows a DC motor 40 with a drive shaft 46 mounted directly to an eccentric cam 120. The small link member 122 and cam follower 124, as well as motor 40, are identical to those described above with respect to FIGS. 6 and 7. The small link member 122 pivots about the pivot point 126, similar to structures described with respect to FIGS. 6 and 7. Again, because of the flexible hinge 125 formed in the link member 122, the flossing member (not shown) follows only the vertical movement of the eccentric cam 120. In this embodiment, the motor is positioned relatively close to the flossing member.

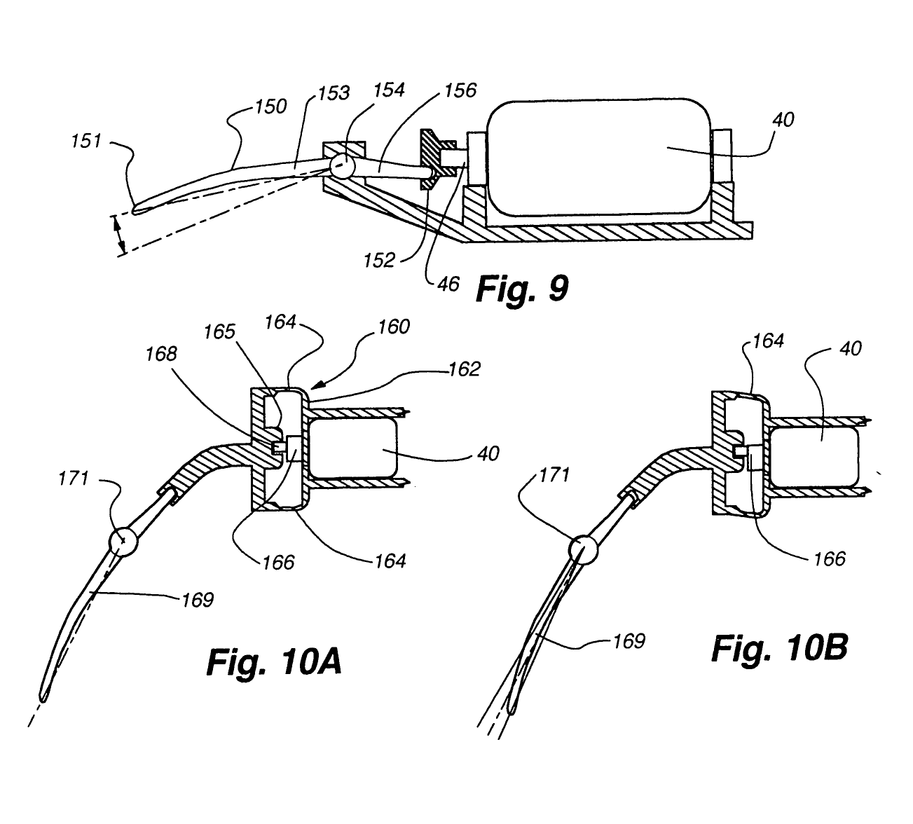

FIG. 9 shows a structure similar to that of FIG. 8, except the tip 150 is attached directly to the off-center eccentric cam 152 mounted on the motor drive shaft 46, as opposed to being attached to a cam follower. The tip 150 combines both a tip member 151 and a small pivot arm 153, and includes the pivot point 154 and the flexible hinge 156. The examples shown in FIGS. 8 and 9 generally require a DC motor sufficiently small to fit in the tip portion of the housing. This embodiment, depending on available space and motor capability, may use the fewest drive mechanism components. With the redesigned combination tip 150, the small pivot arm may be eliminated. The biggest difference between the function of the present tip design and those discussed above, with respect to prior figures, is that the use of a tip employing the long rocker arm design yields “single plane” oscillation, where use of the above-listed simplified design yields orbital motion unless additional steps are taken. For example, the tip beam engaging the eccentric cam may be constructed to flex easily in the lateral direction but be stiff in the vertical direction. Or, as described above with the various embodiments, the engagement between the tip 150 and the eccentric cam 152 could follow the cam only in vertical movement and not in side-to-side, or lateral, movement.

Another option to obtain more pure “single plane” oscillation would be to create a “living flex” cantilever beam structure 160 utilizing a subframe 162 in the housing, as shown in FIGS. 10A and 10B. This could take the eccentric rotational motion from the motor and turn it into “single plane” translatory oscillation. FIG. 10A shows a frame structure 162 having a living hinge 164 at the top and bottom portions to isolate orbital movement of the eccentric cam 166, resulting in solely linear vertical motion at the tip of the flossing member 168. A subframe 165 is attached to an offset drive shaft 168. The frame structure 164 is rigid in lateral and other non-vertical directions, thus isolating those motions from the flossing member 169. The combination tip 169 may be similar to that discussed with respect to FIG. 9. FIG. 10B shows the frame 164 flexed upwardly, thus pushing the flossing member downwardly about the subframe 165 connection. The frame 164 flexes downwardly to the same degree in order to generate the stroke depicted. For reference, in FIG. 10A, the frame is in the un-flexed position. This structure is basically a pair of opposing flexible hinges, each having a laterally extending flexing axis formed on a sub-frame 165.

Another option related to this “living flex” concept is to eliminate with the tip pivot 171 and simply have a tip attached to a projection of the living flex element. This would enhance the sealability of the unit, since the projection of the living flex element could be sealed to the main structure. However, depending on the space available, it may be necessary to position the motor and flex mechanism a significant distance away from the actual tip (i.e., more than 1.5 inches).

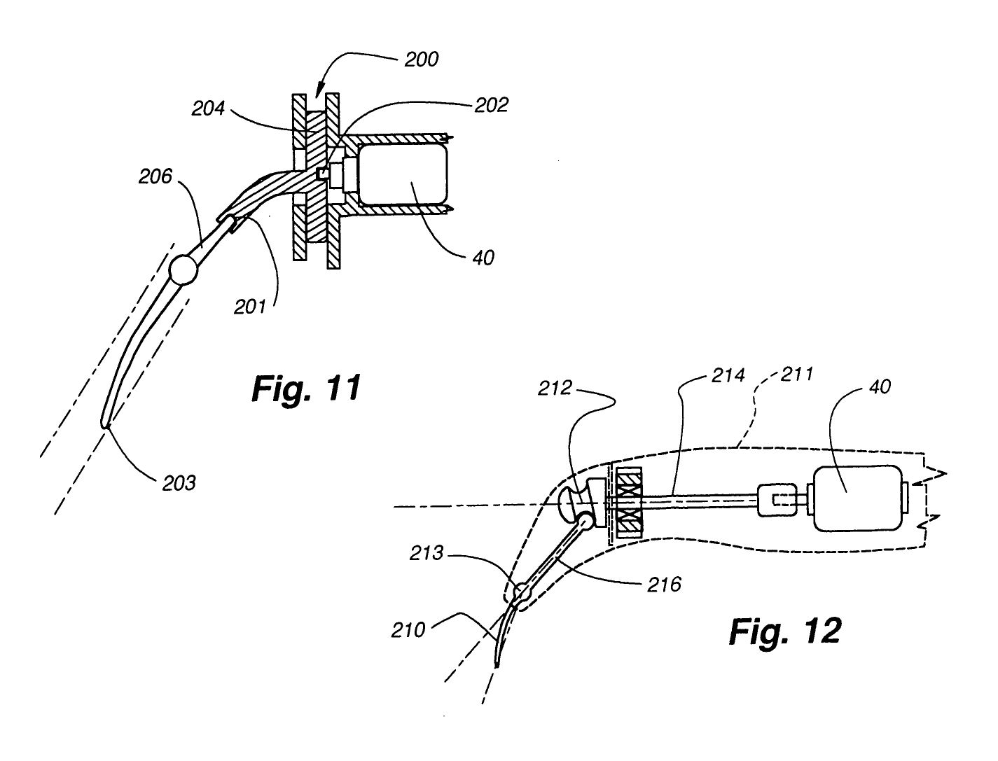

Another variation on this structure would be to replace the living flex portion 160 of the mechanism with a slide channel 200 in the subframe of the housing, as shown in FIG. 11. This structure 200 may require less force to move the tip holder 201 since it is not flexing a member to create movement, but rather sliding a preferably low-friction free-flowing element. 204 However, depending on the distance to the tip 203, a binding condition could exist in the slide channel 200 contact area, which could degrade performance.

In FIG. 11, the off-center cam 202 is attached to a slider 204, which is positioned in the slide channel 200, with the entire slider 204 moving up and down. Since the flossing element 206 is attached directly to the slider 204, the entire flossing tip 203 moves up and down in pure translation, without any pivoting motion. See the outer dashed lines in FIG. 11 to show the approximate upper and lower positions. The angle of the flossing member 206 relative to the motor 40 is easily adjustable by simply adjusting the angle at which the flossing member attaches to the slide member 204. In this structure, the slide channel 200 allows only a substantially vertical movement of the slider 204.

Turning now to FIG. 12, yet another embodiment of a drive mechanism will be discussed. Another embodiment using pure rotary input motion with the motor 40 somewhat remote from the tip 210 may include a track cam 212 attached to a motor shaft 214, with an end of a link member 216 engaging the track cam 212. The tip member 210 is pivotally mounted to the housing 211 such that when the tip member 210 moves in the cam track 212, the external portion of the tip member 210 moves in a vertical arc. The first half of the link member 216 can be flexible to isolate side-to-side movement during actuation by the track cam 212, thus only permitting the vertical movement through the pivot point 213.

One benefit of this embodiment of a flosser drive mechanism is that only two elements are required: the motor 40 and the rotating track cam 212. The replaceable tip 210 is driving directly from the track cam 212. Since the motor bearings and bushings support the end of the track cam shaft, if the shaft needs to be long because of space constraints, then only one additional bearing surface should be required to constrain the shaft. However, if space constraints allow the motor 40 to be positioned close to the tip actuation point, then the motor bearings and bushings may support the shaft by themselves. Also, the pure rotation employed by the present embodiment may result in better balancing for a flosser 30 than the eccentric cam set up discussed above. With only the lightweight plastic flossing tip oscillating, handle vibration is generally minimized. An optional seal may be positioned on the track cam shaft 212 to further reduce vibration and/or noise. Also, the angled end portion of the device could be color-coded and interchangeable for different family members to use as contemplated.

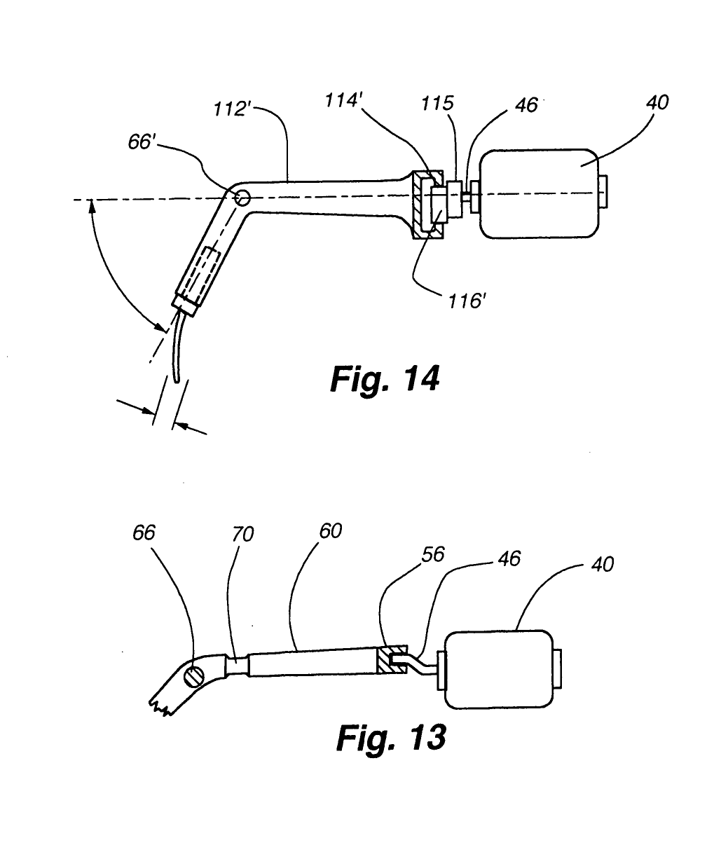

FIG. 13 shows an alternative structure for attaching the link member 60 to the drive shaft 46. The drive shaft has an offset portion engaged in the first end 56 of the link member 60. The offset portion acts like the combination of the drive member 62 and recess 64 of the structure in the embodiment of FIGS. 1, 2 and 3.

FIG. 14 shows another alternative embodiment of the drive mechanism, similar to that of FIG. 7, with a more significant angle between the first and second portions of the link member 112′. In this embodiment, the cam follower 114′ follows a cam device 116′, which is attached to a drive member 115, which is in turn attached to the drive shaft 46. The offset angle formed between the portions of the link member 112′, (i.e., those on either side of the pivot 66′) allow for different relative positions of the flossing member with respect to the motor.

The linear drive linkage of the present invention efficiently converts pure rotary motion to oscillating translatory motion (pivotal up and down movement through a vertical plane) for effective flossing action of interproximal gaps between one's teeth. The structures described herein minimize or eliminate side to side movement of the tip member by isolating vertical movement from lateral movement through the drive structure between the rocker arm and the motor drive shaft. In some embodiments, a combination horizontal pivot and vertically oriented flexible section of the rocker arm are used in combination to isolate the up and down vertical motion and eliminate the side to side or lateral motion.

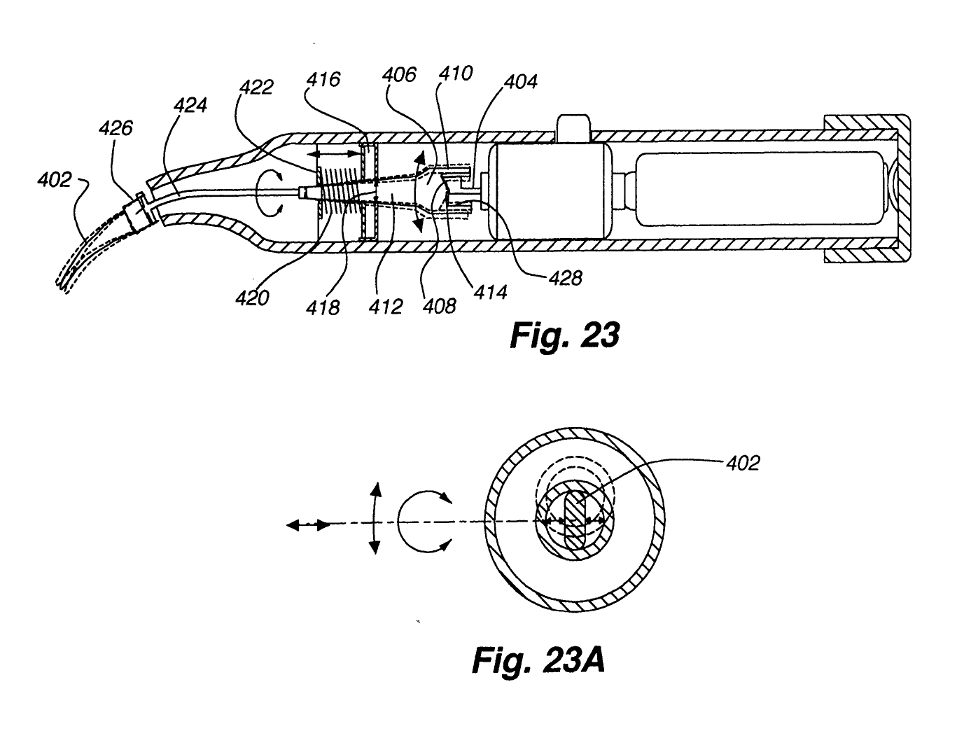

FIGS. 23-26 illustrate alternative embodiments of drive mechanisms, each transferring multiple types of movement to the associated flosser tip members. Each of these alternative embodiments cause a flosser tip to exhibit two or more of the following types of motion when in use: (i) reciprocating axial motion; (ii) vibratory motion; and/or (iii) rotating movement.

FIG. 23 shows a flosser incorporating an alternative embodiment of the drive mechanism. The drive mechanism illustrated in FIG. 23 causes the tip member 402 to move in axial, vibrating, and rotating motions. In FIG. 23, a motor drive shaft 404 is connected to an eccentric cam 406 having an angled top surface 408. The cam 406 is loosely received within an open cup-like end 410 of a pivot arm 412. A bottom-facing surface 414 of the pivot arm 412, defined within the open cup 410 that mates with the angled top surface 408 of the cam 406, is angled in a complementary manner to that of the cam's top surface. Further, the bottom-facing surface 414 of the pivot arm 412 generally forms a track in which the cam's angled top surface travels during rotation.

The cam 406 is offset relative to the shaft 404 of the motor. Accordingly, rotation of the cam 406 causes vibration, which is transferred to the pivot arm 412. As the cam 406 follows the track formed in the pivot arm 412, the top angled surface 408 presses against the pivot arm's bottom facing surface 414, thereby causing the pivot arm 412 to move upward.

The pivot arm 412 is connected to a floating support 416. The floating support 416 is received over the pivot arm 412 through a center opening 418, and is prevented from sliding down the pivot arm 412 by the larger diameter of the underlying portion of the frustoconically-shaped pivot arm. Further, the outside edge of the floating support 416 is slightly smaller than the corresponding inner diameter of the device's housing. The pivot arm 412 extends through a spring 420 located above the floating support 416. A bottom end of the spring 420 is braced against a top surface of the floating support 416. A top end of the spring 420 is connected to a spring anchor 422, wherein the spring anchor 422 is fixedly attached to the housing of the device.

As the pivot arm 412 is forced upward from contact with the top angled surface 408 of the cam 406, the floating support 416 (which is braced against the pivot arm 412 to prevent downward movement of the floating support) is also forced upwardly, thereby compressing the spring 420 against the spring anchor 422. As the angled top surface 408 of the cam 406 continues to rotate in the track, the pivot arm 412 returns to its original position, with the spring 420 biased against the spring anchor 422. The spring 420 thus forces the floating support 416 downward, along with the pivot arm 412, to its original position.

Above the spring anchor 422, a link member 424 is connected at one end with the top of the pivot arm 412. Further, the end of the link member 424 opposite the end connected to the pivot arm 412 includes means for connecting 426 a replaceable flosser tip member 402. Accordingly, the reciprocal axial movement of the pivot arm 412, as facilitated by the angled cam 406 and the spring 420, also causes the floss tip member 402 to move axially up and down. The flosser tip connecting means 426 may be the same as is described herein, or any other suitable attachment structure.

In addition to supporting the spring 420, the floating support 416 also provides a focal pivot point, wherein a portion of the pivot arm's movements at the cup-like end 410 of the pivot arm 412 are reflected at the top of the pivot arm. This vibrational movement, which is typically orbital in nature (e.g., circular or elliptical motion about the long axis of the pivot arm 412) is imparted to the link member 424 at its interconnection with the top of the pivot arm 412, and is finally imparted to the floss tip member 402 at its interconnection with the top of the link member 424.

Further, in alternate embodiments of the invention, the vibration imparted to the floss tip member 402 may be radial (i.e., in a linear direction at right angles to the long axis of the pivot arm 412), as opposed to orbital, in nature. For example, the shape and size of the floating support 416 may be designed in such a way as to restrict the ultimate vibration of the floss tip member 402 to a strictly linear or radial path.

Finally, the flosser tip member 402 also moves rotationally. As the eccentric cam 406 is spun by the motor, the outside surface of the cam 406 is thrust into contact with the side walls 428 of the downward-facing, open cup 410 of the pivot arm 412. As mentioned above, the primary result of this interaction is orbital vibratory movement of the pivot arm 412, which is ultimately transferred to the flosser tip member 402. Additionally, the centrifugal force acting against the inside surfaces of the pivot arm cup 410 causes sufficient friction to impart a portion of the cam's rotation to the pivot arm 412, thus causing the link member 424 and the flosser tip 402 to rotate as well. It is to be appreciated that the side wall 428 and cam 406 are in a sliding engagement and the rotational speed imparted to the pivot arm 412 is only a fraction of the rotational speed of the cam.

In alternate embodiments of the present invention, the motor may cause the eccentric cam 406 to move rotationally in a reciprocating manner, thus ultimately providing a reciprocating rotation movement to the flosser tip 402.

To summarize, the tip member 402 is connected with the link member 424. The link member 424 is connected to the pivot arm 412 and cam 406. The pivot arm 412 moves orbitally or radially (i.e., vibrationally), axially, and rotationally. These motions are translated to the link member 424 and ultimately to the tip member 402. Accordingly, in this embodiment, the tip member 402 moves in axial, vibrating, and rotating manners, as indicated in FIG. 23A.

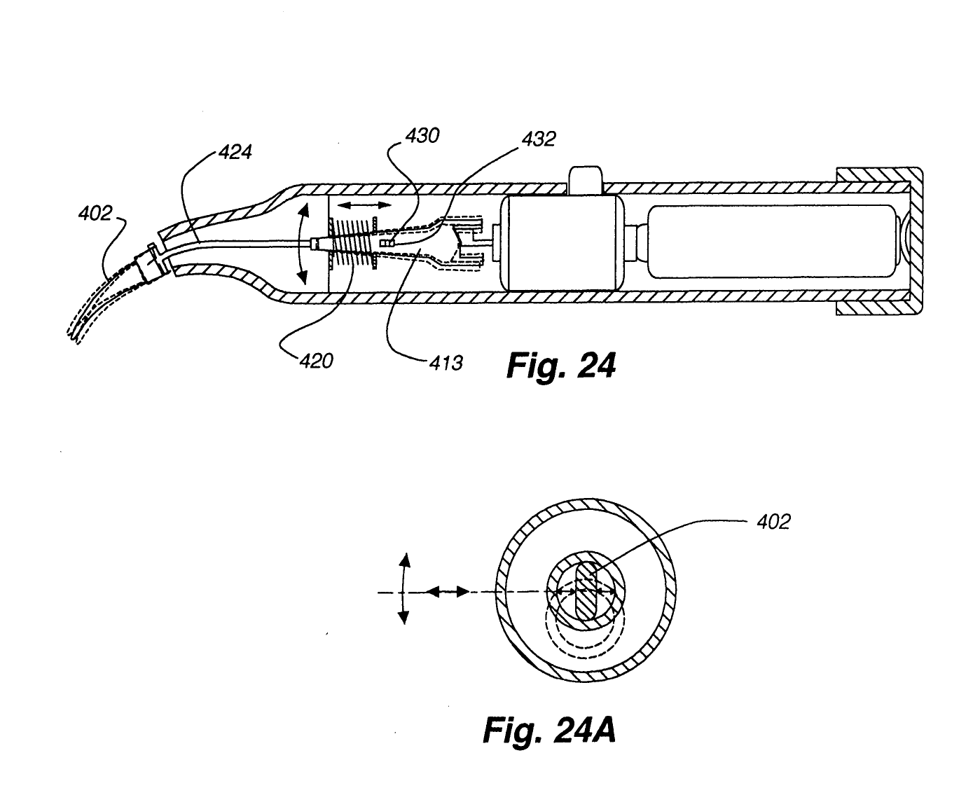

FIG. 24 shows another alternative embodiment drive mechanism that is generally similar in certain respects to that of FIG. 23. In this embodiment, however, a pivot arm pin 430 replaces the similarly positioned floating support 416 in the FIG. 23 embodiment, thereby causing the tip member 402 to move in reciprocating axial and orbital vibrating motions but not a rotating motion. As shown in FIG. 24, the pivot arm 413 is prevented from rotating by a pivot arm pin 430 running through the pivot arm 413 and joining the pivot arm to the inside of the device housing. The pivot arm pin 430 extends through an elongated opening 432 in the pivot arm 413. The elongated opening 432 allows axial movement of the pivot arm 413, and also acts as a pivot point, permitting vibrational movements between the pivot arm 413 and link member 424. This connection allows the pivot arm 413 to transfer axial and vibrating motions to the link member 424 without causing the link member to rotate. FIG. 24A is a top cross-section view of the flossing device illustrating the motion of the tip member 402 during operation.

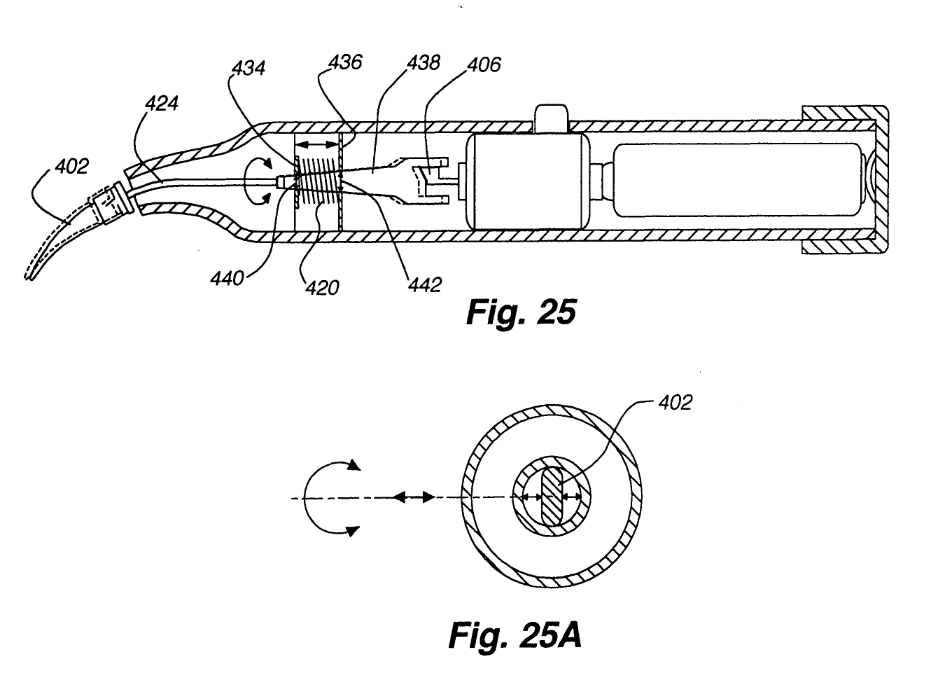

FIG. 25 shows an alternative embodiment of the drive mechanism in cross-section, similar to that shown in FIGS. 23-24 with a drive mechanism that permits the tip member 402 to move only in axially reciprocating and rotating motions. Unlike the embodiment in FIG. 23, the embodiment illustrated in FIG. 25 does not cause the tip member 402 to vibrate, nor does it include a floating support. Unlike the embodiment in FIG. 24, the embodiment illustrated in FIG. 25 does not cause the tip member 402 to vibrate, but does cause the tip member to rotate. Further, this embodiment does include upper 434 and lower 436 vibration-dampening-supports, with the bottom end of an associated spring 420 being fixed to the lower vibration-dampening support 436.

In the embodiment shown in FIG. 25, the vibration-dampening supports 434, 436 are formed from two cross-sectional collars, each of which include center holes 440, 442 encircling a rotating arm 438. The perimeter of each vibration-dampening support collar is joined with the inside walls of the device housing. The top support collar is adjacent the bottom of the link member 424 and top of the rotating arm 438 and also acts to anchor the top end of the spring 420. The lower support collar is adjacent the bottom end of the spring 420, acting with the top collar and the spring to control axial motion of the rotating arm 438 in much the same manner as the combination of floating support and spring anchor shown in FIG. 23.

The interaction between the center holes 440, 442 of the upper and lower supports 434, 436 and the rotating arm 438 brace the arm, thereby preventing the arm from vibrating in an orbital manner at or above the location of the supports. The lower portion of the rotating arm 438 shown in the FIG. 25 continues to move in an orbital motion, due to interaction with the off-center cam 406. The central portion of the rotating arm 438 (the segment proximate the vibration dampening supports 434, 436), however, is prevented from moving radially on all sides by the center holes 440, 442 of the upper and lower supports. This, in turn, dampens any orbital vibrations within the rotating pivot arm 438 above the supports 434, 436.

In this embodiment, the connection between the bottom of the link member 424 and the top of the rotating arm 438 is the same as the connection between the link member 424 and the pivoting arm 412 in the FIG. 23 embodiment. That is, the bottom portion of the link member 424 is fixed to the top portion of the rotating arm 438, such that the rotating motion of the rotating arm 438 is directly translated to the link member 424, thereby causing the link member to rotate. The vibration-dampening supports 434, 436 also stabilize the rotating arm 438 and link member 424, thereby reducing or preventing transferal of vibration from the rotating arm 438 to the link member 424. As the embodiment illustrated in FIG. 25 operates, the tip member 402 moves in both axially reciprocating and rotating motions. The tip member vibration is minimized by the combination of the vibration dampening support elements 434, 436. FIG. 25A is a top section view of the device and illustrates the motion of the tip member 402 when the device is in operation.

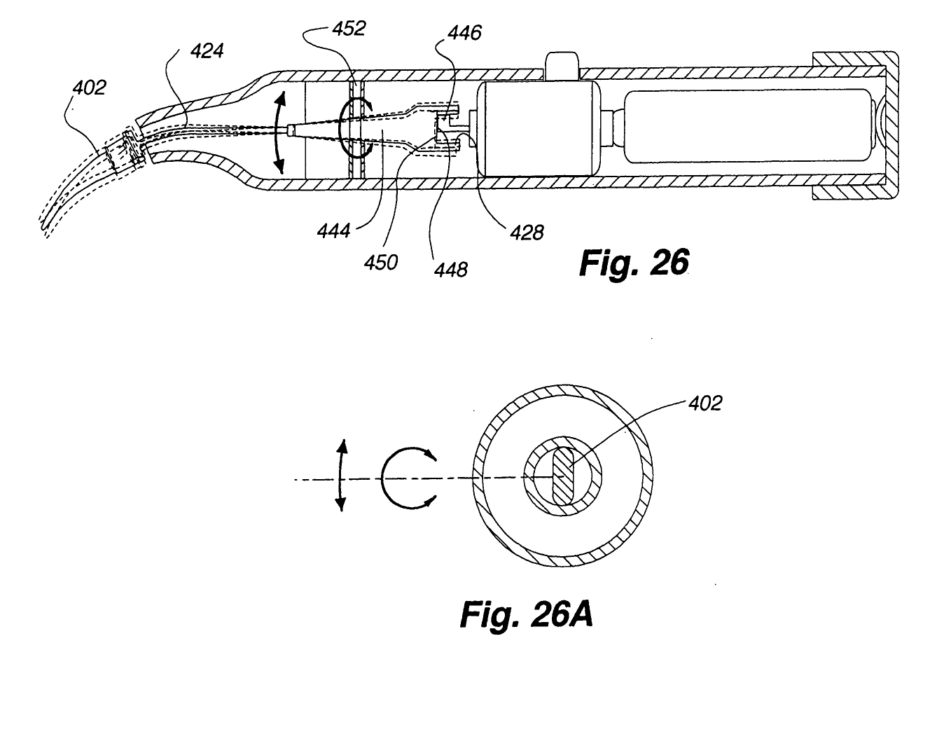

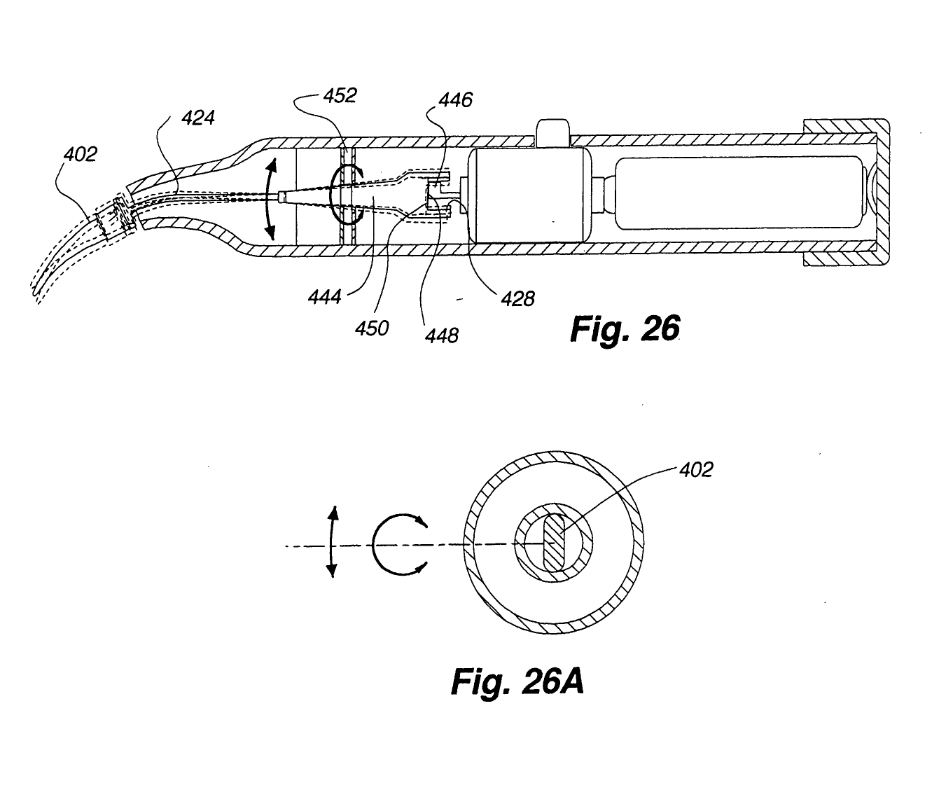

FIG. 26 is an alternative embodiment of the drive mechanism. Unlike the previously described alternative embodiments, this embodiment causes the tip member 402 to both orbitally vibrate and rotate without any appreciable axial movement. The connection between a cam 446 and a pivot arm 444 involves contact between two flat surfaces 448, 450, thereby preventing the pivot arm 444 from axially reciprocating. A pivot support 452 is included in the FIG. 26 embodiment to enhance the transfer of vibrations from the pivot arm 444 to the link member 424 and attached tip member 402. A pivot support collar 452 is generally employed to stabilize the pivot arm 444 during operation of the device, which yields more uniform motion transfer from the pivot arm 444 to the link member 424. Like the lower vibration-dampening support of the FIG. 25 embodiment, the pivot support 452 of this embodiment is typically fixed to the side wall of the device's housing. The link member 424 is connected to the top of the pivot arm 444, resulting in the transfer of vibrational movement to the link member 424, and ultimately to the floss tip member 402, which is connected to the top of the link member 424.

In addition, the cam 446 typically imparts at least some rotational motion to the sidewalls 428 of the pivot arm 444, causing the pivot arm to rotate. The bottom portion of the link member 424 is fixed to the top portion of the pivot arm 444, thereby directly transferring the rotating motion of the pivot arm 444 to the link member 424, and ultimately to the coupled floss tip member 402. Accordingly, the tip member 402 vibrates and rotates as illustrated in the top section view of the tip member 402 in FIG. 26A.

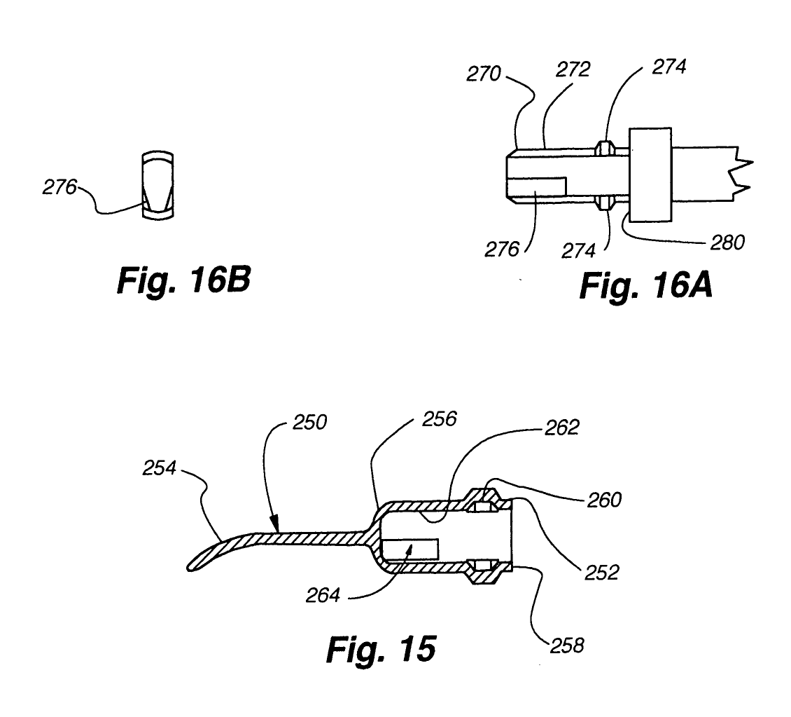

Referring back to FIG. 15, a preferred embodiment of the second end of the link member and the associated floss tip are described below. The tip and link member second end may be used with any of the drive mechanisms described herein.

The second end of the link member receives the tip member. Typically, the tip member is securely attached to the second end of the link member, yet can be easily released therefrom for replacement. FIG. 15 shows the structure of the tip member. The tip member 250 generally includes a tip cap 252; the flossing element 254 extends therefrom.

The flossing element 254 and tip cap 252 are made of plastic. The flossing element 254 extends from the center of the end of the tip cap 252 and can be straight, curved or a combination of both. The flossing element 254 is sized to fit into interdental interproximal spaces. The tip cap 252 has a cup-like shape forming a cavity, with a closed end 256 from which the flossing element extends and an open end 258 operative to receive the second end of the link member. Adjacent the open end 258, an annular groove 260 is formed on the interior wall 262 of the tip cap 252.

As shown in FIG. 15, a keying feature 264 is formed on the lower side walls of the closed end of the tip cap 256. The keying feature 264 can be an angled plane or the like, as described in greater detail below. The tip cap 252 is generally cylindrical, but can be deformed to an oval shape as described below. Alternate embodiments may employ differently shaped tip caps. Also, in some embodiments, the annular groove 260 may not extend around the circumference of the interior of the tip cap at a location adjacent the open end, but instead may consist of two or more diametrically opposed recesses. For example, FIG. 15 shows two such recesses at the top and bottom of the housing 262.

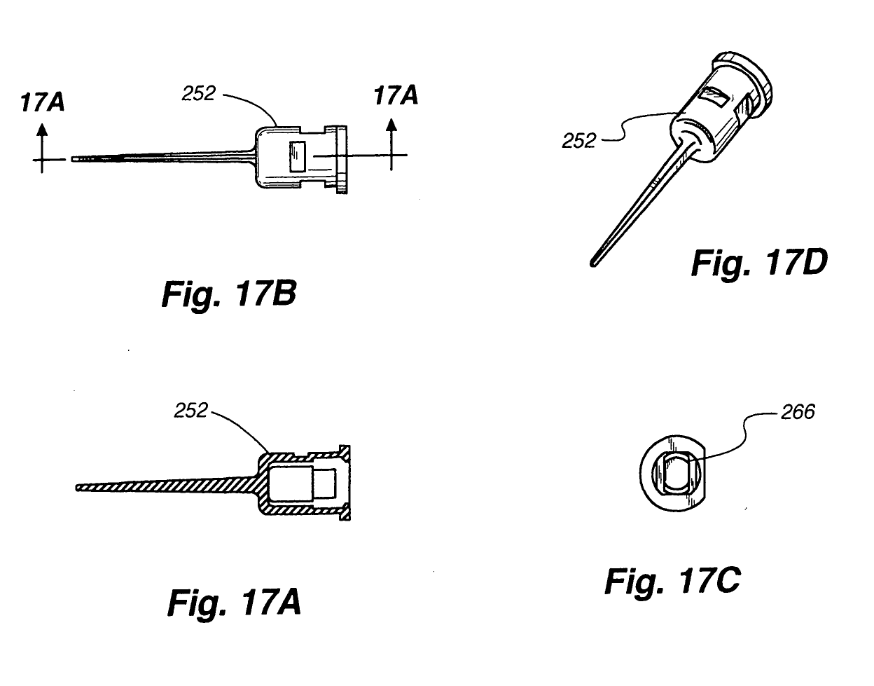

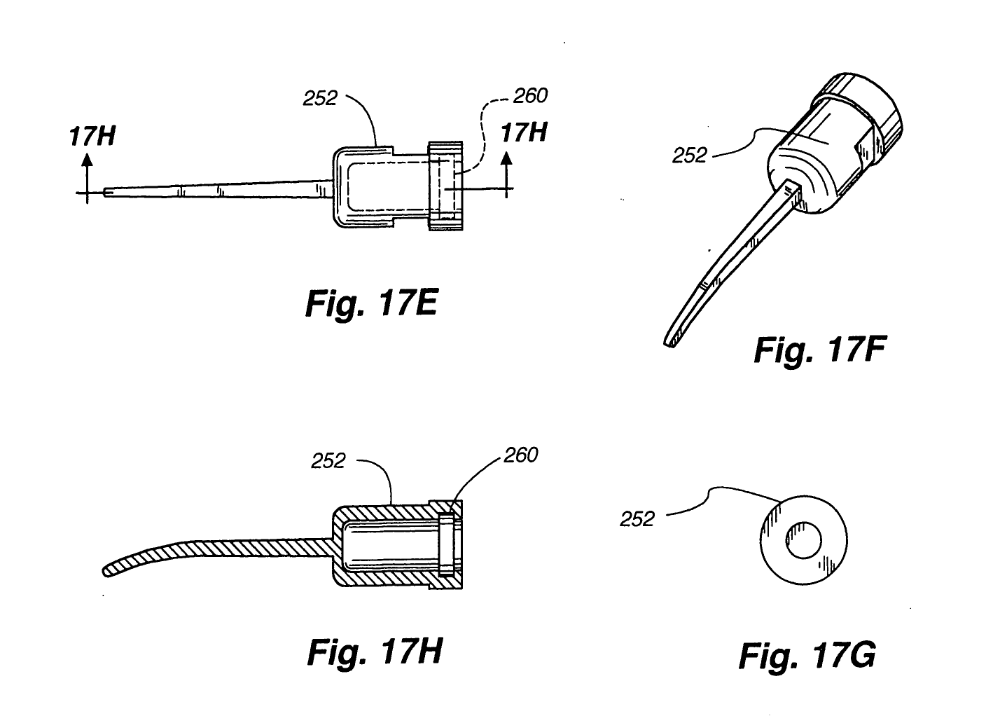

FIGS. 17A, B, C and D also show the tip member. The embodiment shown in these figures lacks a secondary keying feature, instead having a rectangular aperture 266 allowing the tip to be mounted one of two ways on the end of the link member. This is appropriate where the flossing member is straight and thus lacks an angle to indicate relative orientation with respect to the flosser. The tip material is preferably Dupont Zytel 101L or the like, such as NC010 (nylon 66).

FIGS. 16A and 16B show one structure of the second end 270 of the link member 272. Link member 272 is similar to link member 60 described above, and can be used in any embodiment described herein. The second end of the link member is sized to fit within the tip cap shown in FIG. 15, and includes diametrically opposed latch tabs 274 that snap into the latching recesses 260 when the second end of the link member is inserted into the tip cap 252. A keying structure 276 is incorporated into the second end to mate with the keying structure 264 of the tip. The key structure can have a primary key and a secondary key. The primary key is typically used whether the tip is curved or straight, and insures the tip is mounted so that it vibrates along the narrower (lateral) axis of the blade and fits appropriately between the user's teeth. The primary key helps insure that the end of the link member is rectangular and only accepts the tip in the proper orientations.

The secondary key is used where the tip is curved, and thus has easily discernable up and down orientations. A keying feature 276 is defined near the second end 270 of the link member 272 to mate with the secondary keying feature 264 inside the tip cap 252. This secondary keying feature allows the tip cap 252 to be positioned in only one orientation on the second end of the link member in the event the flossing element is curved and requires a particular orientation for proper use. The secondary keying feature is typically not present unless a particular orientation of the tip cap 252, when mounted on the second end of the link member, is desired. Other types of secondary keying features can be used, including other geometrical shapes, notches, grooves, or the like, to allow an engagement of the keying features for insertion of the second end of the link member into the tip cap. The preferred secondary keying feature described herein is preferred because of its ease of manufacture and simplicity.

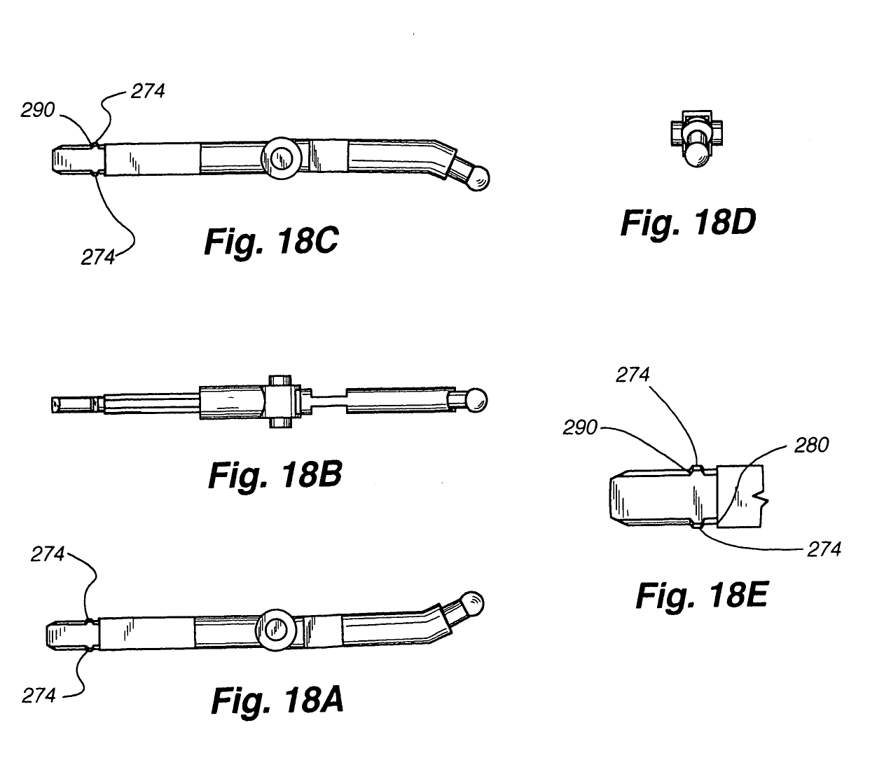

As shown in FIG. 18E, sealing surface 280 is defined on the second end 270 of the link member 272, spaced away from the latch tabs 274 and away from the free end of the link member. The rim of the tip cap 252 engages the sealing surface 280 (which can be an annular boss formed around the link member).

FIGS. 18A-E generally depict an alternative embodiment of the second end of the link member. This embodiment does not require a keying feature. The link member is similar to that shown in FIGS. 1, 2 and 3.

FIGS. 17E, F, G and H show an embodiment of the tip cap 252 and flossing element 254. The external surface of the tip cap 252 adjacent the rim defines opposed notches. The primary and secondary keying structures are combined in this structure by having a pie-shaped opening in the tip cap to receive a correspondingly-shaped second end of the link member.

In operation, the enclosed latching recess 260 in the tip cap 252 engages the latching tabs 274 on the mechanism (the second end of the link member) to hold the tip in place. The keying feature prevents the tip from being installed in the improper orientation. The tip is disengaged from the second end of the link member by compressing the sides of the tip cap 252 to deform it into essentially an elliptical shape. This creates a major axis of an ellipse which would be larger than the distance across the latching tabs 274 on the second end of the link member. The tip may then be easily removed, because the latch tabs disengage from the latch grooves when the sidewalls are squeezed.

A tip-holding cartridge could provide the compression means for insertion or removal without the user directly contacting the tip. There is a gap formed on either side of the second end of the link member when inserted in the tip cap to allow the tip cap to be squeezed to form an elliptical shape. The tip cap can deformed to an ovalized or non-circular shape to release the latch tabs 274 from the latch recesses 260.

This detent-style tip connection allows for secure placement of the tip member on the second end of the link member yet also allows for convenient removal of the tip member from the second end of the link member. When the tip member is positioned on the second end of the link member, an audible “click” is heard when the tip member is correctly seated thereon. This assures the user that the tip member is attached to the device.

The latch tabs 274 can have at least a sloped front surface 290 (see FIG. 18E) to allow for a sliding engagement of the tip cap 252 over the second end of the link member, so that the tip cap 252 is gradually increased in size to allow the latch tabs 274 to seat in the latching recess 260. The tip cap 252 is sufficiently resilient to rebound to its circular shape to cause the latch tabs 274 to be received in the latch recesses 260 and thus hold the tip on the second end of the link member.

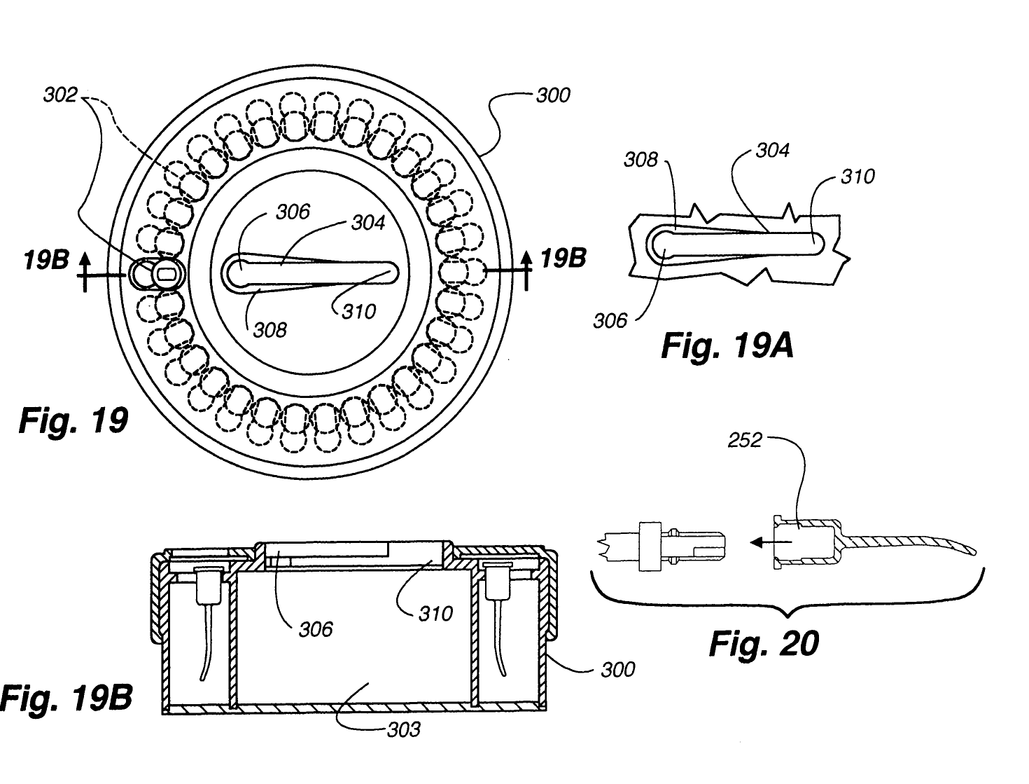

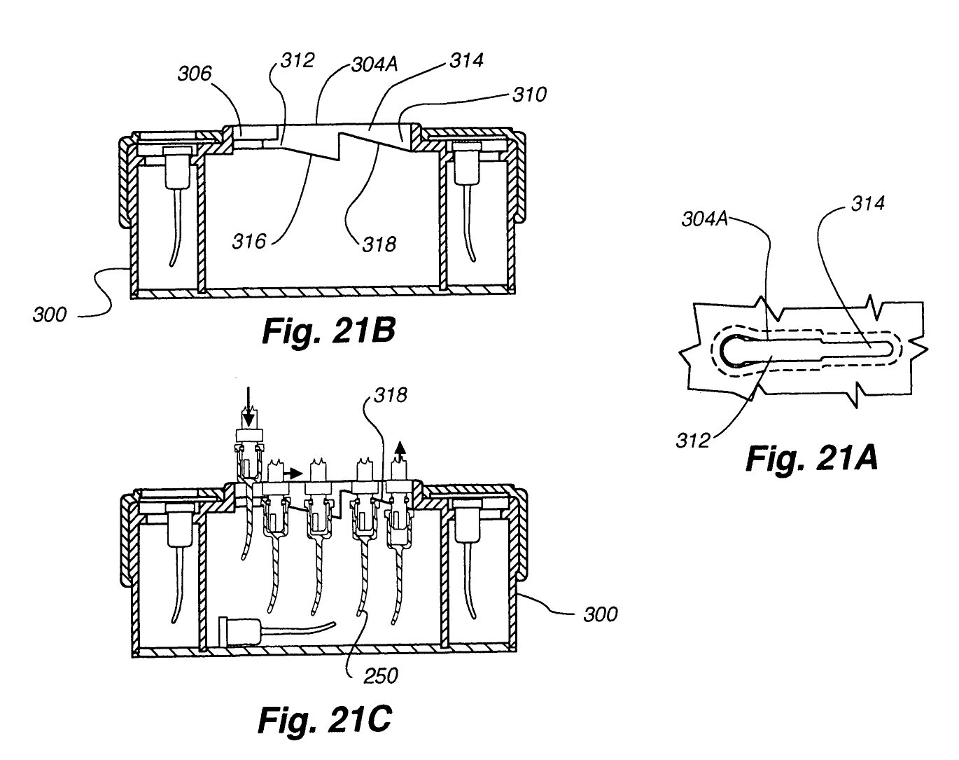

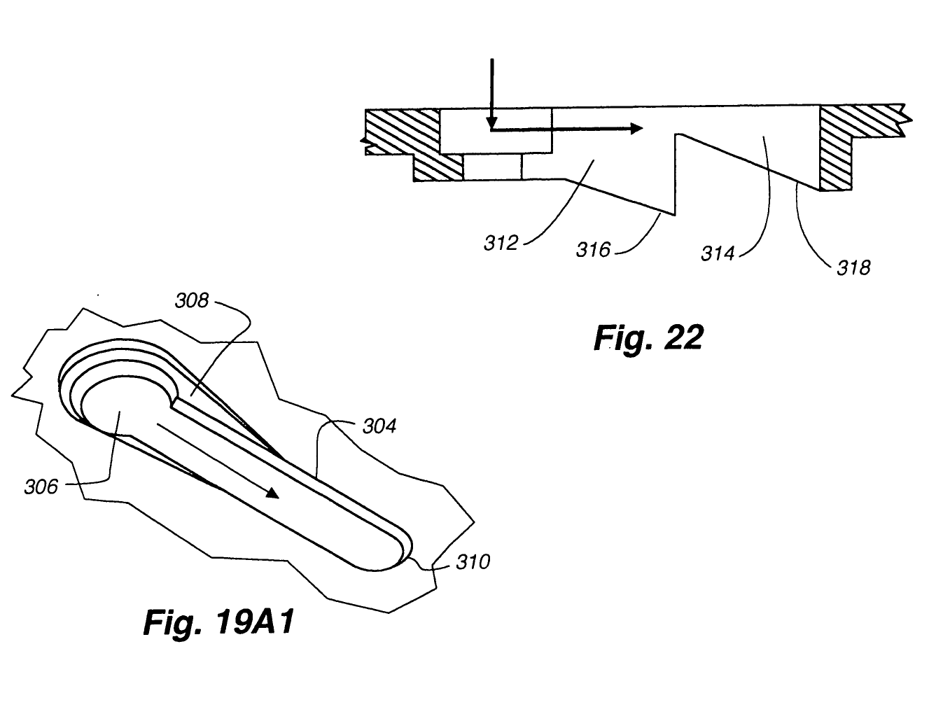

The tip can be removed from the second end of the link member by squeezing those sides of the tip offset approximately 90 degrees from the engagement of the latch members 274 with the latch recesses 260 in the tip cap 252. Compressing the tip cap 252 at this location causes the tip cap to form an elliptical or oval shape, disengaging the latch tabs from the latch recesses 260 and allowing the tip cap 252 to be removed from the device. This can be done by hand, with a tool (such as pliers) or by the tip removal device shown in FIGS. 19, 21, and 22.

FIG. 19 shows a flosser tip cartridge 300 including several replacement flosser tip members 302 positioned circumferentially around the outer rim of the top cap, and a specially formed slot 304 formed across the center of the top cap. Once the flosser tip 250 is attached to the second end of the link member, as is shown in FIG. 20, the flosser tip is releasably attached thereto. To remove the flosser tip from the second end of the link member, the flosser tip 250 is inserted into the slot 304 at the first end 306, as shown by arrows on FIG. 19B, and moved along the slot 304 to compress the opposing sides of the tip cap 252. This releases the latch tabs 274 and allows the tip 250 to fall into the reservoir 303 for collection and disposal.

The first end 306 of the slot 304 has a substantially circular shape to allow the insertion of the tip 250 therethrough. The upper edges 308 of the slot 304 slope outwardly at the first end 306 and gradually transition to a vertical orientation about halfway between the first end 306 and the second end 310 of the slot. The seal collar 280 (shown in FIG. 15), formed around the second end of the link member, rests on the top edge of the slot 304. As the tip 250 is moved along the slot, the sides are compressed by the side walls of the slot 304. This causes the tip cap 252 to deform into an elliptical shape, allowing the latch tabs 274 to release from the latch recesses 260. FIG. 19A1 depicts another representation of the slot shown in FIGS. 19A and B. The sides of the slot 304 generally engage opposing notches on the sides of the tip cap 252. At the second end 310 of the slot 304, when the flossing device is pulled upwardly from the slot 304, the tip 250 is held in the slot 304 such that it is removed from the second end of the link member.

FIGS. 21A, B and C show another embodiment of this tip removal device where the slot 304A is broken into at least two sections: one section 312 similar to that shown in FIGS. 20A and B where the tip is deformed into an elliptical shape such that the latch tabs 274 are released from the latch recesses 260 in the tips, and a second section 314 where the tip 250 is forcibly removed and ejected from the second end of the link member without having to remove the second end of the link member from the slot 304. This structure entirely removes the flosser tip 250 from the second end of the link member and ejects it into the receptacle cavity. The first end 306 of this slot 304A in FIG. 21A receives the flosser tip 250. As the flosser tip 250 is moved along the slot 304A, a first downwardly sloped surface 316 (FIG. 21B) on either side of the slot 304A engages the sides of the flosser tip 250 to compress the flosser tip 250 into an elliptical shape and release the latch mechanisms to allow the flosser tip to be slid towards the end of the second end of the link member. The sidewalls generally engage the opposing notches on the tip cap 252, pushing the tip cap along the second end of the link member by moving down the ramp as the cap is moved along the first section of the slot.

At the second section 314 of the slot 304A, a second downwardly sloping ramp 318, offset upwardly from the first downwardly sloping ramp, is formed on either side of the slot 304A. This ramp 318 is shown in FIG. 21B, and engages the top side of the rim of the tip cap 252 to further force the flosser tip 250 off the second end of the link member as the device is moved to the second end of the slot. See FIG. 21C.

FIG. 22 shows an enlarged view of the slot 304A structure in cross-section. Again, the slot ramp 316 acts to compress the tip cap 252 forming an elliptical shape to disengage the latch tabs 274 and push the flosser tip 250 partially from the second end of the link member. The final ejection ramp 318 in the second section 314 of the slot engages the rim of the flosser tip, pushing the entire flosser tip off the second end of the link member as the device is moved to the second end 310 of the slot 304A.

Additional features may facilitate ejecting the tip from the end of the device and are summarized here. The tip 250 is inserted into the release slot 304A. As the tip 250 slides along the slot 304A and compresses to release the latch tabs 274, it is also guided down the slot ramp 316. Thus, the tip 250 is pulled down and off the attachment end of the device. As the tip 250 clears the end of the slot ramp 316, the rim of the tip cap 252 contacts the final ejection ramp 218 and is pushed clear of the tip attachment end of the device (see FIG. 21C).

The automatic removal of the flosser tip from the end of the device allows the user to easily replace the tips by sliding the second end of the link member along the slot, removing the tip member and easily replacing the tip by simply inserting it into a new flosser tip stored adjacent to the slot.

While the invention has been particularly shown and described with reference to a certain embodiments, it will be understood by those skilled in the art that various other changes in the form and details may be made without departing from the spirit and scope of the invention. Accordingly, the proper scope of the invention is defined by the appended claims.

1. An interproximal flosser comprising:
a motor with a rotational drive shaft;
a link member comprising first and second ends, said first end being adapted to receive a removable floss tip member; and
motion translation means for transferring rotational motion of said drive shaft to said second end of said link member in the form of at least two of the group consisting of vibrational motion, rotational motion, and axial motion.

2. The interproximal flosser of claim 1, wherein the vibrational motion is orbital in nature.

3. The interproximal flosser of claim 1, wherein the vibrational motion is radial in nature.

4. An interproximal flosser comprising:
a motor with a rotational drive shaft;
a link member comprising first and second ends, said first end being adapted to receive a removable floss tip member; and
motion translation means for transferring rotational motion of said drive shaft to said second end of said link member in the form of axial motion.

5. An interproximal flosser comprising:
a body;
a motor coupled with said body, said motor comprising a rotational drive shaft;
a link member comprising first and second ends, said first end being adapted to receive a removable floss tip member; and
a motion translator configured to transfer rotational motion of said drive shaft to said link member in the form of at least two of the group consisting of vibrational motion, rotational motion, and axial motion.

6. The interproximal flosser of claim 5, wherein the vibrational motion is orbital in nature.

7. The interproximal flosser of claim 5, wherein the vibrational motion is radial in nature.

8. The interproximal flosser of claim 5, said motion translator comprising:
an eccentric cam configured to engage said rotating drive shaft, said cam comprising an angled top surface;
a pivot arm having a top end and a bottom end, said top end attached with said second end of said link member and said bottom end coupled with said cam, said bottom end defining an angled track engaging said angled top surface of said cam;
a floating support coupled with said pivot arm; and
a spring including a top end and a bottom end, said top end coupled with said body and said bottom end configured to engage said pivot arm;
wherein upon rotation of said drive shaft, said eccentric cam is rotated by said drive shaft, thereby causing said pivot arm and said link member to exhibit vibrating, rotating, and axial motions.

9. The interproximal flosser of claim 8, said pivot arm further comprising an open cup with inner side walls, said angled track of said pivot arm located inside said open cup, said cam engaging said inner side walls.

10. The interproximal flosser of claim 8, said floating support defining a hole, said pivot arm extending therethrough.

11. The interproximal flosser of claim 5, said motion translator comprising:
an eccentric cam configured to engage said rotating drive shaft, said cam comprising an angled top surface;
a pivot arm comprising a top end and a bottom end, said top end attached with said second end of said link member and said bottom end coupled with said cam, said bottom end defining an angled track engaging said angled top surface of said cam;
a pivot arm pin operatively coupled with said pivot arm to prevent rotation of said pivot arm; and
a spring including a top end and a bottom end, said top end coupled with said body and said bottom end configured to engage said pivot arm;
wherein upon rotation of said drive shaft, said eccentric cam is rotated by said drive shaft, thereby causing said pivot arm and said link member to exhibit vibrating and axial motions.

12. The interproximal flosser of claim 11, said pivot arm further comprising an open cup with inner side walls, said angled track of said pivot arm located inside said open cup, said cam engaging said inner side walls.

13. The interproximal flosser of claim 11, said pivot arm defining an elongated opening, said pivot arm pin extending therethrough.

14. The interproximal flosser of claim 5, said motion translator comprising:
an eccentric cam configured to engage said rotating drive shaft, said cam comprising an angled top surface;
a rotating arm having a top end and a bottom end, said top end attached with said second end of said link member and said bottom end coupled with said cam, said bottom end defining an angled track engaging said angled top surface of said cam;
an upper and a lower vibration-dampening support coupled with said rotating arm; and
a spring including a top end and a bottom end, said top end coupled with said body and said bottom end configured to engage said rotating arm;
wherein upon rotation of said drive shaft, said eccentric cam is rotated by said drive shaft, thereby causing said rotating arm and said link member to exhibit rotating and axial motions.

15. The interproximal flosser of claim 14, said rotating arm further comprising an open cup with inner side walls, said angled track of said rotating arm located inside said open cup, said cam engaging said inner side walls.

16. The interproximal flosser of claim 5, said motion translator comprising:
an eccentric cam configured to engage said rotating drive shaft, said cam comprising a flat top surface;
a pivot arm having a top end and a bottom end, said top end attached with said second end of said link member and said bottom end coupled with said cam, said bottom end defining a flat surface engaging said flat top surface of said cam; and
a pivot support coupled with said pivot arm;
wherein upon rotation of said drive shaft, said eccentric cam is rotated by said drive shaft, thereby causing said pivot arm and said link member to exhibit vibrating and rotating motions.

17. The interproximal flosser of claim 16, said pivot arm further comprising an open cup with inner side walls, said flat surface of said pivot arm located inside said open cup, said cam engaging said inner side walls.

18. A drive mechanism for an interproximal flosser having a body and an electric motor with a rotating drive shaft, said drive mechanism comprising:
a link member having a first end and a second end, said first end configured to receive a tip member;
an eccentric cam configured to cooperate with the rotating drive shaft, said cam including an angled top surface;
a pivot arm having a top end and a bottom end, said top end attached with said second end of said link member and said bottom end loosely connected with said cam, said bottom end defining an angled track for receiving said cam, said angled track of said pivot arm engaging said angled top surface of said cam;
a floating support connected with said pivot arm; and
a spring including a top end and a bottom end, said top end coupled with the body and said bottom end configured to engage said pivot arm via said floating support;
wherein when the drive shaft rotates, said eccentric cam is rotated by the drive shaft, thereby causing said pivot arm to exhibit vibrating, rotating, and axial motions, thereby transferring said motions of said pivot arm to said first end of said link member.

19. A drive mechanism for an interproximal flosser having a body and an electric motor with a rotating drive shaft, said drive mechanism comprising:
a link member having a first end and a second end, said first end configured to receive a tip member;
an eccentric cam configured to cooperate with the rotating drive shaft, said cam including an angled top surface;
a pivot arm having a top end and a bottom end, said top end attached with said second end of said link member and said bottom end loosely connected with said cam, said bottom end defining an angled track for receiving said cam, said angled track of said pivot arm engaging said angled top surface of said cam;
a pivot arm pin operatively coupled with said pivot arm to prevent rotation of said pivot arm; and
a spring including a top end and a bottom end, said top end coupled with the body and said bottom end configured to engage said pivot arm;
wherein when the drive shaft rotates, said eccentric cam is rotated by the drive shaft, thereby causing said pivot arm to exhibit vibrating and axial motions, thereby transferring said motions of said pivot arm to said first end of said link member.

20. A drive mechanism for an interproximal flosser having a body and an electric motor with a rotating drive shaft, said drive mechanism comprising:
a link member having a first end and a second end, said first end configured to receive a tip member;
an eccentric cam configured to cooperate with the rotating drive shaft, said cam including an angled top surface;
a rotating arm having a top end and a bottom end, said top end attached with said second end of said link member and said bottom end loosely connected with said cam, said bottom end defining an angled track for receiving said cam, said angled track of said rotating arm engaging said angled top surface of said cam;
an upper and a lower vibration-dampening support coupled with said rotating arm; and
a spring including a top end and a bottom end, said top end coupled with the body and said bottom end coupled with said rotating arm;
wherein when the drive shaft rotates, said eccentric cam is rotated by the drive shaft, thereby causing said rotating arm to exhibit rotating and axial motions, thereby transferring said motions of said rotating arm to said first end of said link member.

21. A drive mechanism for an interproximal flosser having a body and an electric motor with a rotating drive shaft, said drive mechanism comprising:
a link member having a first end and a second end, said first end configured to receive a tip member;
an eccentric cam configured to cooperate with the rotating drive shaft, said cam including a flat top surface;
a pivot arm having a top end and a bottom end, said top end attached with said second end of said link member and said bottom end loosely connected with said cam, said bottom end defining a flat surface for receiving said cam, said flat surface of said pivot arm engaging said flat top surface of said cam; and
a pivot support coupled with said pivot arm;
wherein when the drive shaft rotates, said eccentric cam is rotated by the drive shaft, thereby causing said pivot arm to exhibit vibrating and rotating motions, thereby transferring said motions of said pivot arm to said first end of said link member.
